(19) United States
(12) Patent Application Publication
(10) Pub. No.: US 2025/0343249 A1
(43) Pub. Date: Nov. 6, 2025

(54) CARBON ELECTRODE FOR AN ELECTROCHEMICAL CELL, AND RELATED METHODS AND SYSTEMS

(71) Applicants: Battelle Energy Alliance, LLC, Idaho Falls, ID (US); University of Maine System of Board of Trustees, Orono, ME (US)

(72) Inventors: Lucun Wang, Idaho Falls, ID (US); Wei Wu, Idaho Falls, ID (US); Dong Ding, Idaho Falls, ID (US); Min Wang, Idaho Falls, ID (US); Yingchao Yang, Orono, ME (US)

(21) Appl. No.: 18/865,665

(22) PCT Filed: May 17, 2023
(86) PCT No.: PCT/US2023/067111

§ 371 Date: Nov. 13, 2024

Related U.S. Application Data
(60) Provisional application No. 63/343,414, filed on May 18, 2022.

(51) Int. Cl. H01M 4/96; H01M 4/86; H01M 4/88; H01M 4/90

(52) U.S. Cl. CPC H01M 4/96; H01M 4/8673; H01M 4/8867; H01M 4/9041; H01M 2004/8689

(57) ABSTRACT

An electrochemical cell is disclosed. The electrochemical cell may include a first electrode including carbon nanotubes and one or more catalysts formulated to accelerate one or more non-oxidative deprotonation reactions to produce at least one hydrocarbon compound, H⁺, and e⁻ from at least one other hydrocarbon compound, a second electrode, and an electrolyte between the first electrode and the second electrode. The carbon nanotubes may be oriented at least substantially vertically relative to the electrolyte. Related methods and systems are disclosed.

### CROSS-REFERENCE TO RELATED APPLICATIONS

This application is a national phase entry under 35 U.S.C. § 371 of International Patent Application PCT/US2023/067111, filed May 17, 2023, designating the United States of America and published as International Patent Publication WO 2023/225549 A2 on Nov. 23, 2023, which claims the benefit under Article 8 of the Patent Cooperation Treaty to U.S. Patent Application Ser. No. 63/343,414, filed May 18, 2022.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure generally relate to electrochemical cells (e.g., fuel cells, electrolysis cells). In particular, embodiments of the disclosure relate to materials of positive electrodes of electrochemical cells (e.g., fuel cells, electrolysis cells).

### BACKGROUND

Large reserves of natural gas and natural gas liquids continue to be discovered throughout the world, and have resulted in surpluses of ethane (C₂H₆), which is the second major constituent of natural gas and natural gas liquids after methane (CH₄). C₂H₆ is predominantly used to form ethylene (C₂H₄), a chemical feedstock for plastics (e.g., polyethylene) manufacturing, through conventional steam cracking processes. However, conventional steam cracking processes to convert C₂H₆ to C₂H₄ use high temperatures (e.g., temperatures greater than or equal to about 850° C.) to activate C₂H₆, resulting in undesirable energy expenditures (e.g., thermal energy expenditures) and/or environmental impacts (e.g., greenhouse gas emissions effectuated by the energy needs of the steam cracking processes). In addition, conventional steam cracking processes use complicated and costly systems and methods to purify (e.g., refine) the resulting ethylene product.

Protonic ceramic electrochemical cells (e.g., protonic ceramic fuel cells (PCFCs), protonic ceramic electrolysis cells (PCECs)) have emerged as a highly efficient and environmentally benign approach to direct chemical production and energy conversion at intermediate temperatures (e.g., temperatures within a range of from about 400° C. to about 600° C.). Conventional PCFCs/PCECs include an anode (e.g., positive electrode) formed of a nickel cermet or a solid metal oxide material, especially those with perovskite or related structures. To achieve high electronic and ionic conductivity, the conventional anode materials are usually sintered and fired onto the electrolyte, with both act using temperatures over about 900° C. The harsh thermal treatment of the conventional anode materials results in substantial loss of the active surface area and the catalytic activity. While enhancing the porosity of conventional anodes may effectively increase the specific surface areas, the increase porosity would inevitably lead to deteriorated mechanical strength and flexibility. Furthermore, the widely used Ni-based anode materials for hydrocarbon fuel cells are known to suffer from fast degradation induced by severe coking due to the excessive catalytic activity of metallic Ni in breaking C—C bonds. To overcome this issue, alternative electrocatalysts have been developed, such as Fe, Co, and Ni alloys, which showed different levels of enhanced coking resistance. However, the electrochemical and/or catalytic performance of these alternative electrocatalysts is usually not satisfactory due to inadequate conductivity and/or low catalytic activity.

### BRIEF SUMMARY

This summary does not identify key features or essential features of the claimed subject matter, nor does it limit the scope of the claimed subject matter.

Accordingly, in some embodiments, an electrochemical cell is disclosed. The electrochemical cell comprises a first electrode comprising carbon nanotubes and one or more catalysts formulated to accelerate one or more non-oxidative deprotonation reactions to produce at least one hydrocarbon compound, H⁺, and e⁻ from at least one other hydrocarbon compound, a second electrode, and an electrolyte between the first electrode and the second electrode. The carbon nanotubes are oriented at least substantially vertically relative to the electrolyte.

Accordingly, in some embodiments, a method of forming an electrochemical cell is disclosed. The method of forming an electrochemical cell comprises forming an electrolyte material exhibiting an ionic conductivity greater than or equal to about 10⁻² S/cm at one or more temperatures within a range of from about 350° C. to about 650° C., forming a first electrode comprising carbon nanotubes and one or more catalysts on the electrolyte material, and forming a second electrode on the electrolyte material opposite the first electrode.

Accordingly, in some embodiments, a hydrocarbon activation system is disclosed. The hydrocarbon activation system comprises a source of one or more hydrocarbon compounds, and an electrochemical apparatus in fluid communication with the source of one or more hydrocarbon compounds. The electrochemical apparatus comprises a housing structure configured and positioned to receive a hydrocarbon reactant stream including one or more hydrocarbon compounds from the source of one or more hydrocarbon compounds, and an electrochemical cell within the housing structure. The electrochemical cell comprises a first electrode comprising carbon nanotubes and one or more catalysts substantially homogeneously distributed throughout the carbon nanotubes and formulated to accelerate one or more deprotonation reactions to produce at least one other hydrocarbon compound, H⁺, and e⁻ from the one or more hydrocarbon compounds, a second electrode, and an electrolyte between the first electrode and the second electrode. The carbon nanotubes are oriented at least substantially vertically relative to the electrolyte.

### BRIEF DESCRIPTION OF THE DRAWINGS

The illustrations presented in this disclosure are not meant to be actual views of any particular electrochemical cell or component thereof, but are merely idealized representations employed to describe illustrative embodiments. Thus, the drawings are not necessarily to scale.

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a simplified cross-sectional view of an electrochemical cell, according to embodiments of the disclosure;

FIG. 2 is a simplified cross-sectional view that illustrates a method of forming the electrochemical cell of FIG. 1, according to embodiments of the disclosure;

FIG. 3 is a simplified schematic view of a hydrocarbon activation system including the electrochemical cell of FIG. 1, according to embodiments of the disclosure;

FIG. 4 is an X-ray diffraction (XRD) pattern of an anode including carbon nanotubes (CNTs), as described in Example 4;

FIGS. 5A and 5B are transition electron microscopy (TEM) images of CNTs sampled from an anode including CNTs, as described in Example 5;

FIGS. 6A through 6D are X-ray photoelectron spectroscopy (XPS) spectra for an anode including CNTs, as described in Example 6;

FIGS. 7A and 7B are graphical representations showing current density results (e.g., polarization curves) and power density results of electrochemical cells operated as fuel cells, as described in Example 8;

FIGS. 7C and 7D are graphical representation of results associated with electron impedance spectroscopy (EIS) measurements, as described in Example 8;

FIG. 7E is a graphical representation of catalytic performance results of an electrochemical cell operated as a fuel cell, as described in Example 8;

FIGS. 8A and 8B are graphical representations showing current density results (e.g., polarization curves) and power density results of electrochemical cells operated as fuel cells, as described in Example 9;

FIGS. 8C and 8D are graphical representation of results associated with EIS measurements, as described in Example 9;

FIG. 8E is a graphical representation of catalytic performance results of electrochemical cells operated as fuel cells, as described in Example 9; and

FIG. 8F is a graphical representation of degradation results of electrochemical cells continuously operated as fuel cells for 90 to 100 hours, as described in Example 9.

### DETAILED DESCRIPTION

In the following detailed description, reference is made to the accompanying drawings, which form a part hereof, and in which are shown, by way of illustration, specific examples of embodiments in which the disclosure may be practiced. These embodiments are described in sufficient detail to enable a person of ordinary skill in the art to practice the disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the disclosure. In some instances similar structures or components in the various drawings may retain the same or similar numbering for the convenience of the reader; however, the similarity in numbering does not necessarily mean that the structures or components are identical in size, composition, configuration, or any other property.

It will be readily understood that the components of the embodiments as generally described herein and illustrated in the drawings could be arranged and designed in a wide variety of different configurations. Thus, the following description of various embodiments is not intended to limit the scope of the disclosure, but is merely representative of various embodiments. While the various aspects of the embodiments may be presented in the drawings, the drawings are not necessarily drawn to scale unless specifically indicated.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, acts, features, functions, or the like.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein).

As used herein, the term “electrolyte” means and includes an ionic conductor, which can be in a solid state, a liquid state, or a gas state (e.g., plasma).

As used herein, the term “compatible” means that a material does not undesirably react, decompose, or absorb another material, and also that the material does not undesirably impair the chemical and/or mechanical properties of the another material.

As used herein, the term “carbon nanotube forest (CNTF)” means and includes a population of carbon nanotubes that self-assemble into vertically oriented arrays relative to an underlying electrolyte during growth.

As used herein, the term “triple conducting perovskite” means and includes a perovskite formulated to conduct hydrogen ions (H⁺) (e.g., protons), oxygen ions (O²⁻), and electrons (e⁻). A triple conducting perovskite exhibits a cubic lattice structure, with the general formula ABO_{3-δ}, where A consists of one or more lanthanide elements (e.g., lanthanum (La), cerium (Ce), praseodymium (Pr), neodymium (Nd), promethium (Pm), samarium (Sm), europium (Er), gadolinium (Gd), terbium (Tb), dysprosium (Dy), holmium (Ho), erbium (Er), thulium (Tm), ytterbium (Yb), lutetium (Lu)), B consists of cobalt (Co) and one or more of nickel (Ni), manganese (Mn), and iron (Fe), and δ is the oxygen deficit.

As used herein, the term “catalyst” means and includes a material formulated to promote one or more reactions, resulting in the formation of a product.

As used herein, spatially relative terms, such as “adjacent,” “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, orientation, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

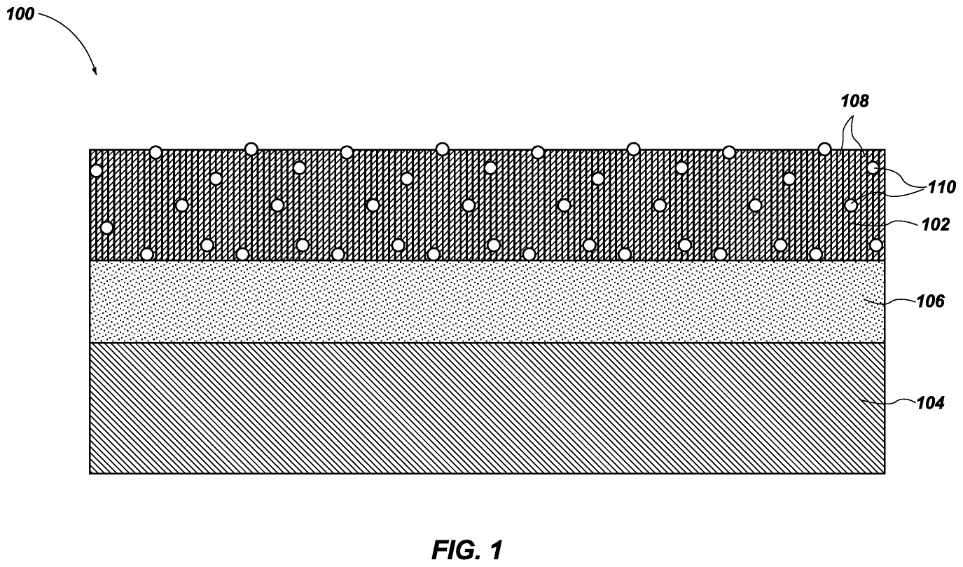

FIG. 1 illustrates a cross-sectional view of an electrochemical cell 100, according to embodiments of this disclosure. As shown in FIG. 1, the electrochemical cell 100 includes a positive electrode 102 (e.g., an anode), a negative electrode 104 (e.g., a cathode), and an electrolyte 106 (e.g., a proton-conducting electrolyte, a proton-conducting membrane) disposed between the positive electrode 102 and the negative electrode 104. In some embodiments, the electrochemical cell 100 is a protonic ceramic electrochemical cell. The electrochemical cell 100 may operate as an electrolysis cell to convert one or more hydrocarbon compounds (e.g., one or more alkanes) into at least one other hydrocarbon compound (e.g., at least one alkene) and may also be used to produce one or more protonation products using hydrogen ions removed from the one or more hydrocarbon compounds. By way of non-limiting example, the electrochemical cell 100 may be used to convert one or more of ethane (C₂H₆), propane (C₃H₈), and butane (C₄H₁₀) into at least one of ethylene (C₂H₄), propylene (C₃H₆), and butylene (C₄H₈), respectively. In some embodiments, the electrochemical cell 100 is used to convert one or more hydrocarbon compounds (e.g., one or more alkanes) into the at least one other hydrocarbon compound (e.g., at least one alkene), and subsequently to convert the at least one other hydrocarbon compound into at least one higher hydrocarbon compound. For example, the electrochemical cell 100 may be used to convert C₂H₆ into one or more of C₄H₈, gasoline (C₈H₁₈), and diesel (C₁₂H₂₃). The electrochemical cell may operate as a fuel cell to generate electricity from produced H_{2(g)}. The electrochemical cell 100 may operate at an operational temperature within a range of from about 350° C. to about 700° C. The electrochemical cell 100 may operate at current densities greater than or equal to about 0.1 amperes per square centimeter (A/cm²), such as greater than or equal to about 0.5 A/cm², greater than or equal to about 1.0 A/cm², or greater than or equal to about 2.0 A/cm². In some embodiments, the electrochemical cell may operate at current densities within a range of from about 0.1 A/cm² to about 3.0 A/cm², such as within a range of from about 1.0 A/cm² to about 2.0 A/cm².

The electrolyte 106 may be a proton-conducting membrane. The electrolyte 106 may be formed of and include at least one electrolyte material exhibiting an ionic conductivity (e.g., H⁺ conductivity) greater than or equal to about 10⁻² S/cm, such as within a range of from about 10⁻² S/cm to about 1 S/cm, at one or more temperatures within a range of from about 350° C. to about 650° C., such as from about 400° C. to about 600° C. The electrolyte material may be formulated to remain substantially adhered (e.g., laminated) to the positive electrode 102 and the negative electrode 104 at relatively high current densities, such as at current densities greater than or equal to about 0.1 A/cm² (e.g., greater than or equal to about 0.5 A/cm², greater than or equal to about 1.0 A/cm², greater than or equal to about 2.0 A/cm²). In some embodiments, the electrolyte 106 is formed of and includes at least one perovskite material having an operational temperature (e.g., a temperature at which the conductivity of the perovskite material is greater than or equal to about 10⁻² S/cm, such as within a range of from about 10⁻² S/cm to about 1 S/cm) within a range of from about 350° C. to about 650° C. The electrolyte 106 may be formed of and include a perovskite material exhibiting a cubic lattice structure with a general formula ABO_{3-δ}, where A may comprise barium (Ba), B may comprise one or more of zirconium (Zr), cerium (Ce), yttrium (Y), and ytterbium (Yb), and Sis the oxygen deficit. By way of non-limiting example, the electrolyte 106 may be formed of and include one or more of a yttrium- and ytterbium-doped barium-zirconate-cerate (BZCYYb), such as BaZr_{0.8-y}Ce_{y}Y_{0.2-x}YbₓO_{3-δ}, where x and y are dopant levels and δ is the oxygen deficit (e.g., BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), BaZr_{0.3}Ce_{0.5}Y_{0.1}Yb_{0.1}O_{3-δ} (BZCYYb3511)), doped barium-zirconate (BaZrO₃) (e.g., yttrium-doped BaZrO₃ (BZY), such as BaZr_{0.8}Y_{0.2}O_{3-δ} where δ is the oxygen deficit), barium-yttrium-stannate (Ba₂(YSn)O_{5.5}), and barium-calcium-niobate (Ba₃(CaNb₂)O₉). In some embodiments, the electrolyte 106 is formed of and includes BZCYYb.

The electrolyte 106 may be at least substantially homogeneous (e.g., exhibiting an at least substantially uniform material composition throughout the electrolyte 106) or may be at least substantially heterogeneous (e.g., exhibiting varying material composition throughout the electrolyte 106). In some embodiments, the electrolyte 106 is at least substantially homogeneous. In additional embodiments, the electrolyte 106 is at least substantially heterogeneous. The electrolyte 106 may, for example, include a stack of at least two (e.g., at least three, at least four, etc.) different electrolyte materials.

The electrolyte 106 may exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape. The dimensions and shape of the electrolyte 106 may be selected such that the electrolyte 106 at least substantially intervenes between opposing surfaces of the positive electrode 102 and the negative electrode 104. A thickness of the electrolyte 106 may at least partially depend on the material composition and thickness of the positive electrode 102. In some embodiments, a thickness of the electrolyte 106 is at least about 100 microns (μm), such as, for example, at least about 150 μm, at least about 200 μm, or at least about 250 μm.

The positive electrode 102 may be formed of and include a material compatible with the material of the electrolyte 106 and a material of the negative electrode 104 under the operating conditions (e.g., temperature, pressure, current density) of the electrochemical cell 100. The material composition of the positive electrode 102 may facilitate production of the at least one other hydrocarbon (e.g., C₂H₄, C₃H₆, C₄H₈, etc.), H⁺, and e⁻ from the one or more hydrocarbon compounds (e.g., C₂H₆, C₃H₈, C₄H₁₀, etc.). As a non-limiting example, the material composition of the positive electrode 102 may facilitate production of C₂H₄, H⁺, and e⁻ from C₂H₆. The positive electrode 102 may be formed of and include a carbon material and a catalyst 110 dispersed throughout the carbon material. The carbon material may be an electrically conductive material. In some embodiments, the positive electrode 102 is formed of and includes a nanostructured carbon material, such as, for example, one or more of carbon nanotubes (CNTs), carbon nanofibers, graphene, and fullerene. In some embodiments, the positive electrode 102 is formed of and includes CNTs 108. The positive electrode 102 may be formed of and include a carbon nanotube forest (CNTF) including the CNTs 108 and the catalyst 110. In additional embodiments, the positive electrode is formed of and includes carbon nanofibers. The positive electrode 102 is, thus, not formed of a perovskite material (i.e., is a non-perovskite material).

The positive electrode 102 may include one or more catalysts 110 formulated to accelerate one or more deprotonation reaction rates to produce the at least one other hydrocarbon (e.g., C₂H₄, C₃H₆, C₄H₈, etc.), H⁺, and e⁻ from the one or more hydrocarbon compounds (e.g., C₂H₆, C₃H₈, C₄H₁₀, etc.). As a non-limiting example, the positive electrode 102 may include one or more catalysts 110 formulated to accelerate C₂H₆ deprotonation reaction rates to produce C₂H₄, H⁺, and e⁻ from the C₂H₆. The one or more catalysts 110 may also be formulated to accelerate one or more coupling reaction rates to synthesize one or more higher hydrocarbon products from the produced at least one other hydrocarbon. As a non-limiting example, the positive electrode 102 may include one or more catalysts 110 formulated to accelerate an ethyl coupling reaction rate to synthesize one or more hydrocarbon products from produced C₂H₄.

As shown in FIG. 1, the positive electrode 102 may include CNTs 108 extending vertically from a surface of the electrolyte 106 (e.g., perpendicular to the surface of the electrolyte 106) adjacent to the positive electrode 102. The CNTs 108 are configured as a CNTF on the electrolyte 106. The CNTs 108 may include one or more of multi-walled nanotubes (MWNTs) and single-walled nanotubes (SWNTs). In some embodiments, the CNTs 108 are MWNTs. The CNTs 108 may exhibit a length (e.g., height) within a range of from about 5 μm to about 50 μm, such as, for example, within a range of from about 10 μm to about 50 μm, from about 15 μm to about 40 μm, or from about 20 μm to about 30 μm. In some embodiments, the CNTs 108 exhibit a length of about 10 μm. The positive electrode 102 may exhibit a thickness approximately equal to the length of the CNTs 108. The CNTs 108 may exhibit any suitable inner diameter and outer diameter. As a non-limiting example, the CNTs 108 may exhibit an inner diameter within a range of from about 0.5 nanometer (nm) to about 110 nm, such as within a range of from about 1 nm to about 100 nm, from about 10 nm to about 80 nm, from about 15 nm to about 60 nm, from about 20 nm to about 50 nm, or from about 25 nm to about 40 nm. The CNTs 108 may exhibit an outer diameter within a range of from about 1 nm to about 120 nm, such as, for example, within a range of from about 10 nm to about 110 nm, from about 15 nm to about 100 nm, from about 20 nm to about 85 nm, from about 20 nm to about 30 nm, from about 35 nm to about 60 nm, from about 30 nm to about 50 nm, or from about 30 nm to about 40 nm. In some embodiments, the CNTs 108 exhibit an inner diameter of about 10 nm and an outer diameter within a range of from about 20 nm to about 30 nm.

The CNTs 108 of the positive electrode 102 may exhibit a volumetric density (e.g., packing density) on the electrolyte 106 within a range of from about 0.02 g/cm³ to about 0.50 g/cm³, such as, for example, within a range of from about 0.10 g/cm³ to about 0.40 g/cm³, from about 0.12 g/cm³ to about 0.35 g/cm³, from about 0.15 g/cm³ to about 0.30 g/cm³, or from about 0.20 g/cm³ to about 0.25 g/cm³. In some embodiments, the CNTs 108 of the positive electrode 102 exhibit a volumetric density of about 0.12 g/cm³. The CNTs 108 may be at least partially vertically aligned (e.g., aligned in a direction perpendicular to the surface of the electrolyte 106). In some embodiments, the CNTs 108 are at least substantially vertically aligned (e.g., oriented) relative to the electrolyte 106, with the CNTs 108 oriented substantially parallel relative to one another. A degree of vertical alignment of the CNTs 108 may depend on the volumetric density of the CNTs 108. For example, a relatively larger volumetric density of the CNTs 108 may result in a relatively higher degree of vertical alignment due to mechanical support provided between adjacent, individual CNTs 108, and a relatively smaller volumetric density of the CNTs 108 may result in a relatively lower degree of vertical alignment of the CNTs 108.

The positive electrode 102 may exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape. The dimensions and shape of the positive electrode 102 may be selected such that the electrolyte 106 at least substantially intervenes between opposing surfaces of the positive electrode 102 and the negative electrode 104. A thickness of the positive electrode 102 may at least partially depend on the length of the CNTs 108. In some embodiments, a thickness of the positive electrode 102 is within a range of from about 5 μm to about 50 μm, such as, for example, within a range of from about 10 μm to about 50 μm, from about 15 μm to about 40 μm, or from about 20 μm to about 30 μm. In some embodiments, a thickness of the positive electrode 102 is about 10 μm. The positive electrode 102 may exhibit an at least substantially uniform thickness across the entirety of the positive electrode 102. In some embodiments, the positive electrode 102 includes a single (e.g., only one) layer of CNTs 108.

The one or more catalysts 110 of the positive electrode 102 may include at least one metal catalyst, such as, for example, one or more transition metals (e.g., iron (Fe), nickel (Ni), cobalt (Co), platinum (Pt), zinc (Zn), molybdenum (Mo), etc.). In some embodiments, the one or more catalysts 110 include at least one carburized metal catalyst, such as, for example, one or more carburized transition metals (e.g., iron carbide (Fe₃C), nickel carbide (Ni₃C), etc.). In some embodiments, the one or more catalysts 110 includes Fe. In some embodiments, the one or more catalysts 110 includes Fe₃C. The positive electrode 102 may include one or more of elemental particles of the one or more catalysts 110, alloy particles individually including an alloy of the one or more catalysts 110, and composite particles including the one or more catalysts 110. Particles (e.g., elemental particles, alloy particles, composite particles) of the one or more catalysts 110 may be nano-sized (e.g., having a cross-sectional width or diameter within a range of from about 1 nm to about 1 μm, such within a range of from about 1 nm to about 100 nm, from about 1 nm to about 50 nm, from about 1 nm to about 25 nm, or from about 1 nm to about 10 nm. In some embodiments, particles of the one or more catalysts 110 have a cross-sectional width or diameter less than or equal to about 50 nm.

The positive electrode 102 may exhibit any amount (e.g., concentration) and distribution of the catalyst(s) thereof, and any catalyst ratios (e.g., of one catalyst to another catalyst) facilitating desired deprotonation reaction rates and desired coupling reaction rates at the positive electrode 102. As shown in FIG. 1, the one or more catalysts 110 may be distributed between adjacent CNTs 108, on exterior walls of the CNTs 108, within the CNTs 108, at the tips (e.g., ends) of the CNTs 108, and/or at any suitable position along the length of the CNTs 108. In some embodiments, the positive electrode 102 includes the catalyst(s) at an amount within a range of from about 0.5% by weight (wt %) to about 10% wt %. In some embodiments, the one or more catalysts 110 are at least substantially homogeneously distributed throughout the positive electrode 102.

The negative electrode 104 may be formed of and include material compatible with the material of the electrolyte 106 and the material of the positive electrode 102 under the operating conditions (e.g., temperature, pressure, current density) of the electrochemical cell 100. The material composition of the negative electrode 104 may facilitate production of one or more protonation products (e.g., H_{2(g)}, H₂O) from H⁺ and e⁻ produced from the hydrocarbon compounds. The material of the negative electrode 104 may be a porous material. The negative electrode 104 may be formed of and include at least one perovskite material. By way of non-limiting example, the negative electrode 104 may be formed of and include one or more of a triple conducting perovskite material, such as Pr(Co_{1-x-y-z}, Niₓ, Mn_{y}, Fe_{z})O_{3-δ}, wherein 0≤x≤0.9, 0≤y≤0.9, 0≤z≤0.9, and δ is an oxygen deficit (e.g., PrNi_{0.5}Co_{0.5}O_{3-δ} (PNC55)), a double perovskite material, such as such as MBa₁₋ₓSrₓCo_{2-y}Fe_{y}O_{5+δ}, wherein x and y are dopant levels, δ is the oxygen deficit, and M is Pr, Nd, or Sm (e.g., PrBa_{0.5}Sr_{0.5}Co_{1.5}Fe_{0.5}O_{5+δ} (PBSCF), NdBa_{0.5}Sr_{0.5}Co_{1.5}Fe_{0.5}O_{5+δ}, SmBa_{0.5}Sr_{0.5}Co_{1.5}Fe_{0.5}O_{5+δ}), a single perovskite material, such as Sm₁₋ₓSrₓCoO_{3-δ} (SSC), BaZr_{1-x-y-z}CoₓFe_{y}Y_{z}O_{3-δ}, or SrScₓNd_{y}Co_{1-x-y}O_{3-δ}, wherein x, y, and z are dopant levels and δ is the oxygen deficit; a Ruddleson-Popper-type perovskite material, such as M₂NiO_{4-δ}, wherein δ is the oxygen deficit and Mis La, Pr, Gd, or Sm (e.g., La₂NiO_{4-δ}, Pr₂NiO_{4-δ}, Gd₂NiO_{4-δ}, Sm₂NiO_{4-δ}); and a single perovskite/perovskite composite material such as SSC-BZCYYb. In some embodiments, the negative electrode 104 is formed of and includes PNC55.

The negative electrode 104 may include one or more catalysts formulated to accelerate one or more reaction rates to produce protonation products (e.g., H_{2(g)}, H₂O) from H⁺ and e⁻. The one or more catalysts of the negative electrode 104 may include at least one metal catalyst, such as one or more of Ni or Pt. The negative electrode 104 may include one or more of elemental particles of the one or more catalysts, alloy particles individually including an alloy of the one or more catalysts, and composite particles including the one or more catalysts. Particles (e.g., elemental particles, alloy particles, composite particles) of the one or more catalysts may be nano-sized (e.g., having a cross-sectional width or diameter less than about 1 μm, such as less than or equal to about 100 nm, less than or equal to about 50 nm, less than or equal to about 25 nm, or less than or equal to about 10 nm. In some embodiments, particles of the one or more catalysts have a cross-sectional width or diameter less than or equal to about 50 nm. The negative electrode 104 may exhibit any amount (e.g., concentration) and distribution of the catalyst(s) thereof, and any catalyst ratios (e.g., of one catalyst to another catalyst) facilitating desired reaction rates at the negative electrode 104.

As another example, the material of the negative electrode 104 may include a non-catalyst-doped material at least substantially free of catalytic particles thereon, thereover, and/or therein, but that still promotes the production of protonation products from H⁺ and e⁻ at the negative electrode 104.

The negative electrode 104 may exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape. The dimensions and shape of the negative electrode 104 may be selected such that the electrolyte 106 at least substantially intervenes between opposing surfaces of the positive electrode 102 and the negative electrode 104. In some embodiments, a thickness of the negative electrode 104 may be within a range of from about 10 μm to about 1000 μm.

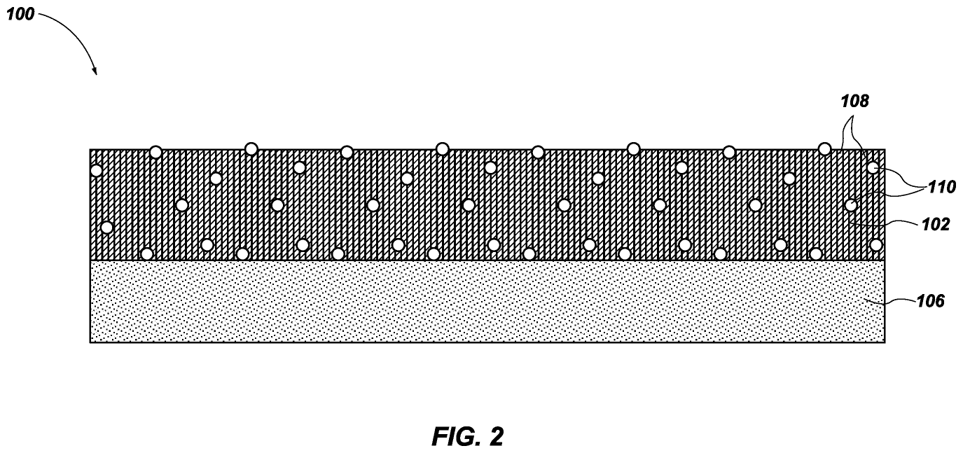

FIG. 2 is a cross-sectional view that illustrates a method of forming the electrochemical cell 100 of FIG. 1, according to embodiments of the disclosure. As shown in FIG. 2, the positive electrode 102 is formed adjacent (e.g., directly adjacent) to the electrolyte 106 and the negative electrode 104 is formed adjacent (e.g., directly adjacent) to an opposite surface of the electrolyte 106. The positive electrode 102 is formed on the electrolyte 106.

The electrolyte 106 may be formed using conventional processes (e.g., rolling processing, milling processing, shaping processes, pressing processes, consolidation processes), which are not described in detail herein. In some embodiments, the electrolyte 106 is formed by a tape-casting process. A green tape of the electrolyte 106 may be prepared by depositing a powder slurry including the electrolyte 106 material(s) onto a substrate having a release material. The powder slurry including the electrolyte 106 material(s) may include one or more of a binder, a dispersant, a solvent, or a plasticizer. The powder slurry may be dried on the substrate to form the green tape of the electrolyte 106.

The green tape of the electrolyte 106 may exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape, in order to produce the desired dimensions of the electrolyte 106.

The green tape of the electrolyte 106 may be pre-annealed (e.g., pre-sintered) at a temperature within a range of from about 800° C. to about 1100° C., such as from about 900° C. to about 1000° C., for a period of time within a range of from about 1 hour to about 5 hours, such as from about 2 hour to about 4 hours or about 3 hours, to remove any organic materials from the green tape of the electrolyte 106. The green tape of the electrolyte 106 may be annealed (e.g., sintered) at a temperature greater than about 1300° C., such as within a range of from about 1300° C. to about 1700° C. or from about 1400° C. to about 1600° C., for a period of time greater than about 3 hours, such as within a range of from about 3 hours to about 7 hours, from about 4 hours to 6 hours, or about 5 hours to form the electrolyte 106. In some embodiments, the green tape of the electrolyte 106 is annealed at a temperature of about 1450° C. for about 5 hours.

After annealing the electrolyte 106, the positive electrode 102 is formed on the electrolyte 106. The positive electrode 102 may include the CNTF including the CNTs 108. In some embodiments, the CNTs are formed by a chemical vapor deposition (CVD) process using a precursor solution including an organometallic material and an organic solvent. The organometallic material may be a source of the one or more catalysts to be included in the positive electrode 102 and a source of the carbon material. For example, the organometallic material may include one or more transition metals (e.g., Fe, Ni, Pt, Zn, Mo, Co, etc.). The organometallic material may include one or more of a metallocene and a metal carbonyl. As a non-limiting example, the organometallic material may include one or more of ferrocene, bis(cyclopentadienyl) nickel (II) (e.g., nickelocene), pentacarbonyl iron, and tetracarbonyl nickel. The organic solvent may include one or more hydrocarbon solvents, such as, for example, one or more of an alkene (CₙH₂ₙ), toluene (C₆H₅CH₃), and xylene (C₈H₁₀). The organic solvent may be a source of the carbon material of the positive electrode 102. The precursor solution may include a ratio of the organometallic material to the organic solvent within a range of from about 0.5 g:20 mL to about 5.0 g:20 mL, such as, for example, within a range of from about 0.8 g:20 mL to about 4.0 g:20 mL, 1.0 g:20 mL to about 3.5 g:20 mL, 1.2 g:20 mL to about 3.0 g:20 mL, 1.5 g:20 mL to about 2.5 g:20 mL, or from about 1.8 g:20 mL to about 2.2 g:20 mL. In some embodiments, the precursor solution includes a ratio of the organometallic material to the organic solvent of about 1.2 g:20 mL.

The CVD process may be performed within a CVD reactor, such as, for example, a tube furnace. The CVD reactor may be a conventional apparatus, which is not described in detail herein. A gas including one or more of an inert gas (e.g., argon) and hydrogen gas (H_{2(g)}) may flow through the CVD reactor at any suitable gas flow rate(s). As a non-limiting example, the gas may include a mixture of argon supplied at a flow rate of about 625 mL/min and H_{2(g)} supplied at a flow rate of about 90 mL/min. The electrolyte 106 may be placed within the CVD reactor and a temperature of the CVD reactor may be increased to a suitable deposition temperature, such as, for example, a temperature within a range of from about 650° C. to about 1200° C. In some embodiments, the CVD reactor is heated to a temperature of about 700° C. In some embodiments, the flow of H_{2(g)} is started after the CVD reactor has been heated to the deposition temperature. The precursor solution may be provided to the CVD reactor and vaporized upon entering the CVD reactor. In some embodiments, a gaseous carbon source is provided to the CVD reactor with the precursor solution. The gaseous carbon source may include one or more of an alkene (CₙH₂ₙ) and acetylene (C₂H₂). The gaseous carbon source may be a source of the carbon material of the positive electrode 102. The vaporized precursor solution may be carried by the inert gas and/or H_{2(g)} to the electrolyte 106 and may decompose on the surface of the electrolyte 106. At least a portion of the metal atoms of the organometallic material may attach to the electrolyte 106 and form nanocatalyst clusters on the surface of the electrolyte 106. The nanocatalyst clusters act as nucleation sites for vertical growth of the CNTs 108 on the electrolyte 106. A layer of CNTs 108 is grown on the electrolyte 106, forming the positive electrode 102 including the CNTF on the electrolyte 106. The layer of CNTs 108 includes at least a portion of the metal atoms of the organometallic material disposed throughout the CNTs 108 as the one or more catalysts 110 of the positive electrode 102.

In some embodiments, at least one of the one or more catalysts 110 may be added to the positive electrode 102 after formation of the positive electrode 102.

The precursor solution may be provided to the CVD reactor for any suitable period of time to form (e.g., grow) the CNTs 108 exhibiting the desired lengths and volumetric densities previously discussed with reference to FIG. 1. For example, the precursor solution may be provided to the CVD reactor for a period of time within a range of from about 1 minute to about several hours, such as, within a range of from about 1 minute to about 10 minutes, from about 1 minute to about 30 minutes, from about 10 minutes to about 1 hour, from about 30 minutes to about 2 hours, or from about 1 hour to about 3 hours. In some embodiments, the precursor solution is provided to the CVD reactor for a period of time less than or equal to about 30 minutes. The volumetric density and length of the CNTs 108 may at least partially depend on the period of time the precursor solution is provided to the CVD reactor. For example, providing the precursor solution for a relatively longer period of time may result in a relatively larger volumetric density and relatively larger length of the CNTs 108 and providing the precursor solution for a relatively shorter period of time may result in a relatively smaller volumetric density and relatively smaller length of the CNTs 108. The volumetric density and length of the CNTs 108 may also at least partially depend on the ratio (e.g., concentration) of the components (e.g., the organometallic material and the organic solvent) of the precursor solution.

The CVD process may be performed at any suitable deposition temperature to form the CNTs 108 having the desired lengths and volumetric densities previously discussed with reference to FIG. 1. The volumetric density and length of the CNTs 108 may at least partially depend on the deposition temperature of the CVD process. For example, performing the CVD process at a relatively higher deposition temperature for a period of time may result in a relatively larger volumetric density and relatively larger length of CNTs 108 and performing the CVD process at a relatively lower deposition temperature for the same period of time may result in a relatively smaller volumetric density and a relatively smaller length of the CNTs 108. Using the CVD process to form the CNTs 108 of the CNTF on the electrolyte 106 increases compatibility between the CNTs 108 and the electrolyte 106.

With reference to FIG. 1, the negative electrode 104 is formed adjacent to (e.g., directly adjacent to) a surface of the electrolyte 106 opposite the positive electrode 102. The negative electrode 104 may be formed using conventional processes (e.g., rolling processing, milling processing, shaping processes, pressing processes, consolidation processes, screen-printing processes, painting processes), which are not described in detail herein. The positive electrode 102, the electrolyte 106, and the negative electrode 104 are annealed at a temperature within a range of from about 700° C. to about 1200° C., such as about 750° C., about 900° C., or about 1000° C., to bond the negative electrode 104 to the electrolyte 106 along a negative electrode-electrolyte interface disposed between the negative electrode 104 and the electrolyte 106 and form the electrochemical cell 100.

The electrochemical cell 100 may exhibit increased catalytic and electrochemical performances as compared to electrochemical cells including conventional anode materials. The CNTs 108 of the CNTF of the positive electrode 102 exhibit high surface area and porosity, allowing for greater loading of electrocatalysts. Furthermore, no high temperature sintering or firing act is used for integration of the positive electrode 102 including the CNTs on the electrolyte 106. Direct in situ formation of active catalyst nanoparticles on and/or within the CNTs of the positive electrode 102 may be achieved in the single act CVD process, which may significantly reduce the manufacturing cost of the electrochemical cell 100. The electrochemical cell 100 may also exhibit improved durability and anti-coking abilities as compared to electrochemical cells including conventional anode materials.

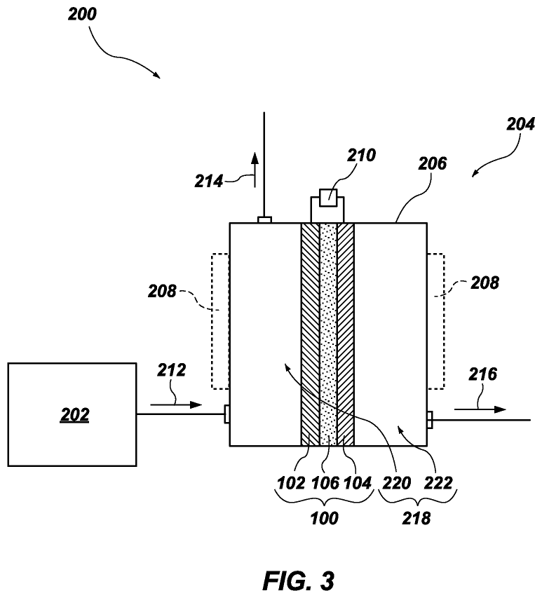

Electrochemical cells (e.g., the electrochemical cell 100) in accordance with embodiments of this disclosure may be used in embodiments of hydrocarbon activation systems of the disclosure. For example, FIG. 3 schematically illustrates a hydrocarbon activation system 200. The hydrocarbon activation system 200 may be used to convert one or more hydrocarbon compounds (e.g., ethane, propane, butane, etc.) into at least one other hydrocarbon compound (e.g., at least one higher hydrocarbon, such as ethylene, propylene, butylene, gasoline, diesel, etc.), and may also be used to produce one or more protonation products (e.g., H_{2(g)}, H₂O) using hydrogen ions (H⁺) (e.g., protons) removed from the one or more hydrocarbon compounds. As shown in FIG. 3, the hydrocarbon activation system 200 may include at least one hydrocarbon source 202 (e.g., containment vessel), and at least one electrochemical apparatus 204 in fluid communication with the hydrocarbon source 202. The electrochemical apparatus 204 includes a housing structure 206, and one or more embodiments of the electrochemical cell 100 previously described with reference to FIGS. 1 and 2 contained within the housing structure 206. The electrochemical cell 100 is electrically connected (e.g., coupled) to a power source 210, and includes the positive electrode 102, the negative electrode 104, and the electrolyte 106 (e.g., the proton conducting membrane) between the positive electrode 102 and the negative electrode 104. As shown in FIG. 3, the hydrocarbon activation system 200 may optionally include at least one heating apparatus 208 operatively associated with the electrochemical apparatus 204.

During use and operation, the hydrocarbon activation system 200 directs a hydrocarbon reactant stream 212 into the electrochemical apparatus 204 to interact with the positive electrode 102 of the electrochemical cell 100. A potential difference (e.g., a voltage) is applied between the positive electrode 102 and the negative electrode 104 of the electrochemical cell by the power source 210 so that as the hydrocarbon interacts with the positive electrode 102, hydrogen (H) atoms of the hydrocarbon release their electrons (e) to generate at least one other hydrocarbon, H⁺, and e⁻ through non-oxidative deprotonation. As a non-limiting example, when the hydrocarbon reactant stream 212 includes ethane (C₂H₆), as the C₂H₆ of the hydrocarbon reactant stream 212 interacts with the positive electrode 102, H atoms of C₂H₆ release their e⁻ to generate ethylene (C₂H₄), H⁺, and e⁻ according to the following equation:

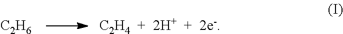

Other hydrocarbon compounds (e.g., propane, butane, etc.) of the hydrocarbon reactant stream 212 may interact with the positive electrode 102 to generate at least one other hydrocarbon, H⁺, and e⁻ according to similar equations.

The generated H′ permeate (e.g., diffuse) across the electrolyte 106 to the negative electrode 104, and the generated e⁻ are directed to the power source 210 through external circuitry. Depending on the material composition of the positive electrode 102, the produced at least one other hydrocarbon may undergo at least one coupling reaction in the presence of one or more catalysts 110 of the positive electrode 102 to synthesize at least one hydrocarbon product (e.g., at least one higher hydrocarbon). As a non-limiting example, C₂H₄ may undergo at least one ethyl coupling reaction in the presence of one or more catalysts 110 of the positive electrode 102 to synthesize at least one hydrocarbon product (e.g., at least one higher hydrocarbon), according to the following equation:

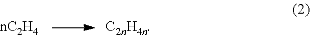

Other hydrocarbon compounds (e.g., propylene, butylene, etc.) produced at the positive electrode 102 may undergo at least one coupling reaction in the presence of one or more catalysts 110 of the positive electrode to synthesize at least one hydrocarbon product (e.g., at least one higher hydrocarbon) according to similar equations.

Hydrocarbon compounds (e.g., C₂H₄, C₃H₆, C₄H₈, higher hydrocarbons) produced at the positive electrode 102 exit the electrochemical apparatus 204 as a hydrocarbon product stream 214 that includes an olefin compound (e.g., an alkene compound).

At the negative electrode 104, generated H⁺ exiting the electrolyte 106 react with e⁻ received from the power source 210 to form H atoms that combine to form H_{2(g)} through a hydrogen evolution reaction, according to the following equation:

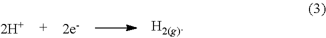

In some embodiments, the hydrocarbon activation system 200 includes an oxygen (O₂) source (not shown) in fluid communication with the electrochemical apparatus 204. In some embodiments, the oxygen source includes air. If the hydrocarbon activation system 200 includes the oxygen source, generated H⁺ exiting the electrolyte 106 may react with O₂ delivered into the electrochemical apparatus 204 from the oxygen source and e⁻ received from the power source 210 to form H₂O, according to the following equation:

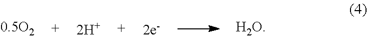

Protonation products (e.g., H_{2(g)}, H₂O) produced at the negative electrode 104 exit the electrochemical apparatus 204 as a protonation product stream 216.

As described in further detail below, the hydrocarbon products synthesized at the positive electrode 102 may at least partially depend on the material composition and flow rate of the hydrocarbon reactant stream 212, the configuration (e.g., size, shape, material composition, material distribution, arrangement) of the positive electrode 102, including the types, quantities, distribution, and properties (e.g., geometric properties, thermodynamic properties, etc.) of catalysts thereof promoting deprotonation reactions and/or coupling reactions, the configuration of the electrolyte 106, and the impact thereof on the diffusivity (e.g., diffusion rate) of generated H₊ therethrough, the configuration of the negative electrode 104, including the types, quantities, and properties (e.g., geometric properties, thermodynamic properties, etc.) of catalysts thereof, and the operation parameters (e.g., temperatures, pressure, etc.) of the electrochemical apparatus 204. Such operation factors may be controlled (e.g., adjusted, maintained, etc.) as desired to control the types, quantities, and rate of production of the hydrocarbon product(s) synthesized at the positive electrode 102 and to control the types, quantities, and rate of production of the protonation product(s) synthesized at the negative electrode 104. In some embodiments, the hydrocarbon product(s) exiting the electrochemical apparatus 204 in the hydrocarbon product stream 214 may be examined (e.g., through in-line gas chromatography-mass spectrometry (GS-MS)) and compared to a mathematically modeled Anderson-Schulz-Flory distribution to analyze whether or not sufficient coupling reactions are occurring at the positive electrode 102 for the synthesis of one or more desired higher hydrocarbon compounds. One or more operational factors of the hydrocarbon activation system 200 (e.g., one or more of the type, quantity, and distribution of catalyst material(s) in the positive electrode 102, the operating temperature of the electrochemical apparatus 204, etc.) may be adjusted or maintained based on the results of the analysis. Accordingly, the operational factors of the hydrocarbon activation system 200 may be tailored to facilitate the production of one or more specific higher hydrocarbon compounds from the components of the hydrocarbon reactant stream 212.

The hydrocarbon reactant stream 212 may be formed of and include one or more lower hydrocarbon compounds (e.g., alkanes, C₁ to C₄ hydrocarbons, such as one or more of CH₄, C₂H₆, C₃H₈, and C₄H₁₀) that may undergo a chemical reaction in the presence of the positive electrode 102 of the electrochemical cell 100 to produce at least one higher hydrocarbon compound, and/or one or more other materials (e.g., H₂, nitrogen (N₂), etc.). In some embodiments, the hydrocarbon reactant stream 212 is formed of and includes a single (e.g., only one) hydrocarbon compound. In additional embodiments, the hydrocarbon reactant stream 212 is formed of and includes multiple (e.g., more than one) hydrocarbon compounds. The hydrocarbon reactant stream 212 may be at least substantially gaseous (e.g., may only include a single gaseous phase), may be at least substantially liquid (e.g., may only include a single liquid phase), or may include a combination of liquid and gaseous phases. The phase(s) of the hydrocarbon reactant stream 212 (and, hence, a temperature and pressure of the hydrocarbon reactant stream 212 may at least partially depend on the operating temperature of the electrochemical cell 100 of the electrochemical apparatus 204. In some embodiments, the hydrocarbon reactant stream 212 is at least substantially gaseous.

A single (e.g., only one) hydrocarbon reactant stream 212 may be directed into the electrochemical apparatus 204 from the hydrocarbon source 202, or multiple (e.g., more than one) hydrocarbon reactant streams 212 may be directed into the electrochemical apparatus 204 from the hydrocarbon source 202. If multiple hydrocarbon reactant streams 212 are directed into the electrochemical apparatus 204, each of the multiple hydrocarbon reactant streams 212 may exhibit at least substantially the same properties (e.g., at least substantially the same material composition, at least substantially the same temperature, at least substantially the same pressure, at least substantially the same flow rate, etc.) or at least one of the multiple hydrocarbon reactant streams 212 may exhibit one or more different properties (e.g., a different material composition, a different temperature, a different pressure, a different flow rate, etc.) than at least one other of the multiple hydrocarbon reactant streams 212.

The heating apparatus 208, if present, may include at least one apparatus (e.g., one or more of a combustion heater, an electrical resistance heater, an inductive heater, and an electromagnetic heater) configured and operated to heat one or more of the hydrocarbon reactant streams 212, and at least a portion of the electrochemical apparatus 204 to an operating temperature of the electrochemical apparatus 204. The operating temperature of the electrochemical apparatus 204 may at least partially depend on a material composition of the electrolyte 106 of the electrochemical cell 100 thereof. In some embodiments, the heating apparatus 208 heats one or more of the hydrocarbon reactant stream 212 and at least a portion of the electrochemical apparatus 204 to a temperature within a range of from about 350° C. to about 650° C., such as from about 400° C. to about 600° C. In additional embodiments, such as in embodiments wherein a temperature of the hydrocarbon reactant stream 212 is already within the operating temperature range of the electrochemical cell 100 of the electrochemical apparatus 204, the heating apparatus 208 may be omitted (e.g., absent) from the hydrocarbon activation system 200.

With continued reference to FIG. 3, the electrochemical apparatus 204, including the housing structure 206 and the electrochemical cell 100 thereof, is configured and operated to form the protonation product stream 216. The housing structure 206 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the electrochemical cell 100 therein, to receive and direct the hydrocarbon reactant stream 212 to the positive electrode 102 of the electrochemical cell 100, to direct the hydrocarbon product(s) synthesized at the positive electrode 102 away from the electrochemical apparatus 204 as the hydrocarbon product stream 214, to optionally receive and direct O₂ (if any) to the negative electrode 104 of the electrochemical cell 100, and to direct protonation products formed at the negative electrode 104 of the electrochemical cell 100 away from the electrochemical apparatus 204 as the protonation product stream 216. In addition, the housing structure 206 may be formed of and include any material (e.g., glass, metal, alloy, polymer, ceramic, composite, combination thereof, etc.) compatible with the operating conditions (e.g., temperatures, pressures, etc.) of the electrochemical apparatus 204.

The housing structure 206 may at least partially define at least one internal chamber 218 at least partially surrounding the electrochemical cell 100. The electrochemical cell 100 may serve as a boundary between a first region 220 (e.g., an anodic region) of the internal chamber 218 configured and positioned to receive the hydrocarbon reactant stream 212 and to direct the hydrocarbon product stream 214 from the electrochemical apparatus 204, and a second region 222 (e.g., a cathodic region) of the internal chamber 218 configured and positioned to receive O₂ from the oxygen source (if any) and to direct the protonation product stream 216 from the electrochemical apparatus 204. Molecules (e.g., hydrocarbons) of the hydrocarbon reactant stream 212 may be at least substantially limited to the first region 220 of the internal chamber 218 by the configurations and portions of the housing structure 206 and the electrochemical cell 100. Keeping the second region 222 of the internal chamber 218 at least substantially free of molecules (e.g., hydrocarbons) from the hydrocarbon reactant stream 212 circumvents additional processing of the protonation product(s) formed at the negative electrode 104 (e.g., to separate the protonation product(s) from hydrocarbon compounds) that may otherwise be necessary if the components of the hydrocarbon reactant stream 212 were also delivered to within the second region 222 of the internal chamber 218. O₂ from the oxygen source, if present, may be at least substantially limited to the second region 222 of the internal chamber 218 by the configurations and portions of the housing structure 206 and the electrochemical cell 100. Keeping the first region 220 of the internal chamber 218 at least substantially free of O₂ from the oxygen source allows non-oxidative deprotonation of the hydrocarbon compounds of the hydrocarbon reactant stream 212 to occur without interference. The non-oxidative environment of the anodic region preserves the chemical inertness of the carbon material of the positive electrode 102 and enables deprotonation of the hydrocarbon compounds using the carbon material, a non-perovskite material, of the positive electrode 102, rather than using a perovskite material as the material of the positive electrode.

As shown in FIG. 3, the positive electrode 102 and the negative electrode 104 of the electrochemical cell 100 are electrically coupled to the power source 210, and the electrolyte 106 is disposed on and between the positive electrode 102 and the negative electrode 104. The electrolyte 106 is configured and formulated to conduct H⁺ from the positive electrode 102 to the negative electrode 104, while electrically insulating the negative electrode 104 from the positive electrode 102 and preventing the migration of molecules (e.g., hydrocarbons) therethrough. Electrons generated at the positive electrode 102 through non-oxidative deprotonation, as described above, may, for example, flow from the positive electrode 102 into a negative current collector, through the power source 210 and a positive current collector, and into the negative electrode 104 to facilitate the production of protonation products (e.g., H_{2(g)}, H₂O), as described above.

Although the electrochemical apparatus 204 is depicted as including a single (e.g., only one) electrochemical cell 100 in FIG. 1, the electrochemical apparatus 204 may include any number of electrochemical cells 100. Put another way, the electrochemical apparatus may include a single (e.g., only one) electrochemical cell 100, or may include multiple (e.g., more than one) electrochemical cells 100. If the electrochemical apparatus 204 includes multiple electrochemical cells 100, each of the electrochemical cells 100 may be at least substantially the same (e.g., exhibit at least substantially the same components, component sizes, component shapes, component material compositions, component material distributions, component positions, component orientations, etc.) and may be operated under at least substantially the same conditions (e.g., at least substantially the same temperatures, pressures, flow rates, etc.), or at least one of the electrochemical cells 100 may be different (e.g., exhibit one or more of different components, different component sizes, different component shapes, different component material compositions, different component material distributions, different component positions, different component orientations, etc.) than at least one other of the electrochemical cells 100 and/or may be operated under different conditions (e.g., different temperatures, different pressures, different flow rates, etc.) than at least one other of the electrochemical cells 100. By way of non-limiting example, one of the electrochemical cells 100 may be configured for and operated under a different temperature (e.g., different operating temperature resulting from a different material composition of one or more components thereof, such as a different material composition of the electrolyte 106 thereof) than at least one other of the electrochemical cells 100. In some embodiments, two or more electrochemical cells 100 are provided in parallel with one another within the housing structure 206 of the electrochemical apparatus 204, and individually produce a portion of the hydrocarbon product(s) directed out of the electrochemical apparatus 204 as the hydrocarbon product stream 214 and a portion of the protonation products (e.g., H_{2(g)}, H₂O) directed out of the electrochemical apparatus 204 as the protonation product stream 216.

In addition, although the hydrocarbon activation system 200 is depicted as including a single (e.g., only one) electrochemical apparatus 204 in FIG. 3, the hydrocarbon activation system 200 may include any number of electrochemical apparatuses 204. Put another way, the hydrocarbon activation system 200 may include a single (e.g., only one) electrochemical apparatus 204, or may include multiple (e.g., more than one) electrochemical apparatuses 204. If the hydrocarbon activation system 200 includes multiple electrochemical apparatuses 204, each of the electrochemical apparatuses 204 may be at least substantially the same (e.g., exhibit at least substantially the same components, component sizes, component shapes, component material compositions, component material distributions, component positions, component orientations, etc.) and may be operated under at least substantially the same conditions (e.g., at least substantially the same temperatures, pressures, flow rates, etc.), or at least one of the electrochemical apparatuses 204 may be different (e.g., exhibit one or more of different components, different component sizes, different component shapes, different component material compositions, different component material distributions, different component positions, different component orientations, etc.) than at least one other of the electrochemical apparatuses 204 and/or may be operated under different conditions (e.g., different temperatures, different pressures, different flow rates, etc.) than at least one other of the electrochemical apparatuses 204. By way of non-limiting example, one of the electrochemical apparatuses 204 may be configured for and operated under a different temperature (e.g., a different operating temperature resulting from a different material composition of one or more components of an electrochemical cell 100 thereof, such as a different material composition of the electrolyte 106 thereof) than at least one other of the electrochemical apparatuses 204. In some embodiments, two or more electrochemical apparatuses 204 are provided in parallel with one another. Each of the two or more electrochemical apparatuses 204 may individually receive a hydrocarbon reactant stream 212 and may individually form a hydrocarbon product stream 214 and a protonation product stream 216.

Still referring to FIG. 3, the hydrocarbon product stream 214 and the protonation product stream 216 exiting the electrochemical apparatus 204 may individually be utilized or disposed of as desired. In some embodiments, the hydrocarbon product stream 214 and the protonation product stream 216 are individually delivered into one or more storage vessels for subsequent use, as desired. In additional embodiments, at least a portion of one or more of the hydrocarbon product stream 214 and the protonation product stream 216 may be utilized (e.g., combusted) to heat one or more components (e.g., the heating apparatus 208 (if present), the electrochemical apparatus 204, etc.) and/or streams (e.g., the hydrocarbon reactant stream 212) of the hydrocarbon activation system 200. By way of non-limiting example, if the heating apparatus 208 (if present) is a combustion-based apparatus, at least a portion of one or more of the hydrocarbon product stream 214 and the protonation product stream 216 may be directed into the heating apparatus 208 and undergo an combustion reaction to efficiently heat one or more of the hydrocarbon reactant stream 212 entering the electrochemical apparatus 204 and at least a portion of the electrochemical apparatus 204. Utilizing the hydrocarbon product stream 214 and/or the protonation product stream 216 as described above may reduce the electrical power requirements of the hydrocarbon activation system 200 by enabling the utilization of direct thermal energy.

Thermal energy input into (e.g., through the heating apparatus 208 (if present)) and/or generated by the electrochemical apparatus 204 may also be used to heat one or more other components and/or streams (e.g., the hydrocarbon reactant stream 212) of the hydrocarbon activation system 200. By way of non-limiting example, the hydrocarbon product stream 214 and/or the protonation product stream 216 exiting the electrochemical apparatus 204 may be directed into a heat exchanger configured and operated to facilitate heat exchange between the hydrocarbon product stream 214 and/or the protonation product stream 216 of the hydrocarbon activation system 200 and one or more other relatively cooler streams (e.g., the hydrocarbon reactant stream 212) of the hydrocarbon activation system 200 to transfer heat from the hydrocarbon product stream 214 and/or the protonation product stream 216 to the relatively cooler stream(s) to facilitate the recovery of the thermal energy input into and generated within the electrochemical apparatus 204. The recovered thermal energy may increase process efficiency and/or reduce operational costs without having to react (e.g., combust) higher hydrocarbon products of the hydrocarbon product stream 214 and/or protonation products of the protonation product stream 216.

The methods, systems (e.g., the hydrocarbon activation system 200), and apparatuses (e.g., the electrochemical apparatus 204, the electrochemical cell 100) of the disclosure facilitate the simple and efficient production of hydrocarbon compounds (e.g., ethylene, butylene, propylene, gasoline, diesel, etc.) and protonation products (e.g., H_{2(g)}, H₂O) from one or more other hydrocarbon compounds at intermediate temperatures, such as temperatures within a range of from about 350° C. to about 650° C., with increased catalytic activity, electrochemical performance, and anti-coking ability. The high efficiency of the positive electrode (e.g., the positive electrode 102) formed of and including the carbon material operating in an electrochemical cell at elevated temperatures, such as temperatures within a range of from about 350° C. to about 650° C., is unexpected. Furthermore, the methods, systems, and apparatuses of the disclosure may reduce degradation of one or more catalysts (e.g., the one or more catalysts 110) of the positive electrode (e.g., positive electrode 102), facilitating improved selectivity for one or more desired hydrocarbon products (e.g., ethylene, propylene, butylene) over a period of time of operation. The methods, systems, and apparatuses of the disclosure may reduce one or more of the costs (e.g., material costs), time (e.g., processing acts), and energy (e.g., thermal energy, electrical energy, etc.) used to produce hydrocarbon compounds relative to conventional methods, systems, and apparatuses of producing hydrocarbon compounds using perovskite-based anodes. The methods, systems, and apparatuses of the disclosure may be more efficient, durable, and reliable than conventional methods, conventional systems, and conventional apparatuses of producing hydrocarbon compounds and protonation products (e.g., H_{2(g)}, H₂O).

The following examples serve to explain embodiments of the disclosure in more detail. These examples are not to be construed as being exhaustive, exclusive, or otherwise limiting as to the scope of the disclosure.

### EXAMPLES

### Example 1

### Materials Synthesis

BZCYYb4411 (e.g., BZCYYb) was synthesized by a solid-state reaction method. Stoichiometric amounts of BaCO₃ (≥99% purity), ZrO₂ (99% purity), CeO₂ (99.9% purity), Y₂O₃ (99.99% purity), and Yb₂O₃ (99.9% purity) were mixed by ball milling in ethanol for 24 hours, followed by drying on a hot plate for 24 hours to form a powder. The powder was pressed under a pressure of 7.5 MPa into pellets including 120 grams of the powder. The pellets were calcined at 1450° C. for 5 hours to obtain phase-pure BZCYYb pellets. The phase-pure BZCYYb pellets were then crushed and ball milled for 24 hours to form phase-pure BZCYYb powder.

PNC55 was synthesized by dissolving stoichiometric amounts of Pr(NO₃)₃·6H₂O (99.9% purity), Ni(NO₃)₂·6H₂O (>99% purity), and Co(NO₃)₂·6H₂O (99% purity) in a citrate-glycine aqueous solution. The citrate-glycine aqueous solution was heated on a hot plate to form a gel. The obtained gel was heated to about 350° C. and followed with an auto-ignition process to produce a voluminous powder ash. The ash was calcined at 1000° C. in air for 5 hours to obtain phase-pure PNC55.

Sr₂Fe_{1.575}Mo_{0.5}O_{6-δ} (SFM) was similarly synthesized by the same method previously described for PNC55 using different precursors. SFM was synthesized using stoichiometric amounts of Sr(NO₃)₂ (99.995% purity), Fe(NO₃)₂·9H₂O (99.9% purity), (NH₄)₆Mo₇O₂₄·4H₂O (99.9% purity).

### Example 2

Cell Fabrication with Carbon Nanotubes

To prepare the electrolyte, BZCYYb powder as described in Example 1 was mixed with plasticizers and binders by ball milling in ethanol and toluene for 48 hours to form a powder slurry. The powder slurry was degassed and tape casting was performed to form an electrolyte tape. The electrolyte tape was thoroughly dried and electrolyte pellets having a diameter of 11.1 mm were punched from the electrolyte tape. The electrolyte pellets were densified at a temperature of 1450° C. for 5 hours. The electrolyte pellets exhibited a thickness of about 200 μm after densification.

The anode was synthesized by a chemical vapor deposition (CVD) method. A precursor solution was prepared by dissolving ferrocene (Fe(C₅H₅)₂) (98% purity) in toluene with a ratio of 1.2 g ferrocene: 20 mL toluene. The precursor solution was filtered to obtain a clear solution. The electrolyte pellets were placed in a quartz tube, having a diameter of 3.62 inches (9.19 centimeters), in a tube furnace. The tube furnace was heated at a ramp rate of 20° C./min to a temperature of 700° C. under a continuous flow of Ar gas at a flow rate of 625 mL/min. Once the tube furnace reached 700° C., H₂ gas was introduced to the quartz tube at a flow rate of 90 mL/min. The precursor solution was provided into the quartz tube with a syringe pump at a flow rate of 5 mL/hour. The precursor solution vaporized immediately upon entering the quartz tube and was carried by the Ar/H₂ gas flow to the electrolyte pellets. The precursor solution decomposed on the surface of the electrolyte pellets and the metal atoms (e.g., iron (Fe)) in the ferrocene attached to the electrolyte surface and formed nanocatalyst clusters. The nanocatalyst clusters acted as nucleation sites for CNTs, and a layer of CNTs (e.g., a CNTF) was grown as the anode on the electrolyte to form a half cell. After 90 minutes, the half cells were cooled down to room temperature in the Ar/H₂ gas flow. The anode, including the layer of CNTs, exhibited a thickness of about 10 μm after formation.

To prepare the cathode, PNC55 powder as described in Example 1 was mixed with ethanol and thinners to form a powder slurry. The powder slurry was screen printed onto a surface of the electrolyte pellets opposite the anode to form a cell. The cell was mounted on a testing fixture and sintered in situ at a temperature of 750° C. for 2 hours. The cathode exhibited a thickness of about 60 μm after sintering.

### Comparative Example 3

Cell Fabrication with SFM Anode

For comparison, a cell was fabricated with conventional anode materials. To prepare the electrolyte, BZCYYb powder as described in Example 1 was mixed with plasticizers and binders by ball milling in ethanol and toluene for 48 hours to form a powder slurry. The powder slurry was degassed and tape casting was performed to form an electrolyte tape. The electrolyte tape was thoroughly dried and electrolyte pellets having a diameter of 11.1 mm were punched from the electrolyte tape. The electrolyte pellets were densified at a temperature of 1450° C. for 5 hours. The electrolyte pellets exhibited a thickness of about 200 μm after densification.

To prepare the anode, SFM powder as described in Example 1 was mixed with ethanol and thinners to form an anode powder slurry. The anode powder slurry was screen printed onto a surface of the electrolyte pellets. To prepare the cathode, PNC55 powder as described in Example 1 was mixed with ethanol and thinners to form a cathode powder slurry. The cathode powder slurry was screen printed onto a surface of the electrolyte pellets opposite the anode powder slurry. The cells were dried and then co-sintered at a temperature of 900° C. for 2 hours.

The SFM anode was pretreated in situ by reduction in 5% by volume (vol %) H₂/Ar at 850° C. for 2 hours to exsolve metallic Fe nanoparticles from the SFM of the anode.

### Example 4

### X-Ray Diffraction (XRD) Measurements

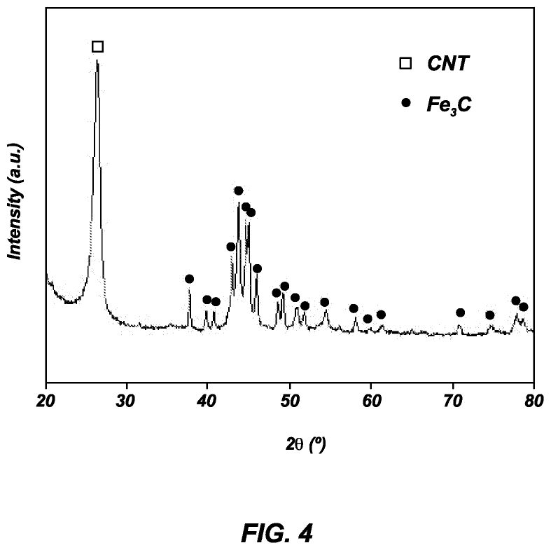

XRD measurements were conducted on the anode of the cell as described in Example 2. FIG. 4 illustrates an XRD pattern obtained from the XRD measurements, where the x-axis is 20 and the y-axis is intensity, where 2θ is the angle between a transmitted beam and a reflected beam. The XRD pattern of FIG. 4 confirmed the bulk structure of the CNTs of the anode by the characteristic diffraction peak of graphite-like carbon at 26.4°. The remaining diffraction peaks between about 35° and 80° represent the orthorhombic Fe₃C phase, indicating that the Fe of the ferrocene precursor was largely carburized during the CVD formation of the anode.

### Example 5

Morphology from Transition Electron Microscopy (TEM) Images

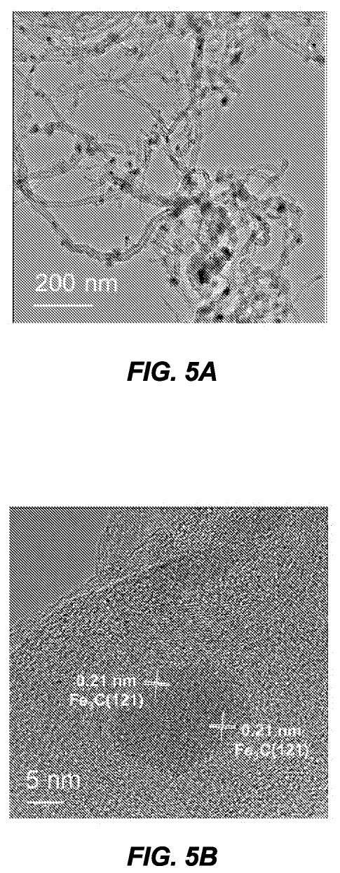

TEM images of CNTs sampled from the anode including CNTs formed on the electrolyte as described in Example 2 were collected. FIGS. 5A-5C illustrate representative TEM images of the CNTs. The TEM image of FIG. 5A is a low-magnification image depicting the CNTs as multi-walled CNTs with an inner diameter of about 10 nm and an outer diameter within a range of from about 20 to about 30 nm. Fe-containing nanoparticles within the CNTs are depicted as darker contrast in comparison to the carbon phase of the CNTs. As shown in FIG. 5A, the Fe-containing nanoparticles were located on the exterior walls of, at the tips of, or confined within the CNTs. The Fe-containing nanoparticles were covered with several carbon shells (e.g., layers). The TEM image of FIG. 5B is a high-magnification image depicting the CNTs including the Fe-containing nanoparticles. As shown in FIG. 5B, the Fe-containing nanoparticles had a lattice distance of 0.21 nm, which corresponds to Fe₃C(121) planes with orthorhombic crystal structure, in accordance with the XRD pattern of Example 5 and FIG. 4.

### Example 6

### X-Ray Photoelectron Spectroscopy (XPS) Measurements

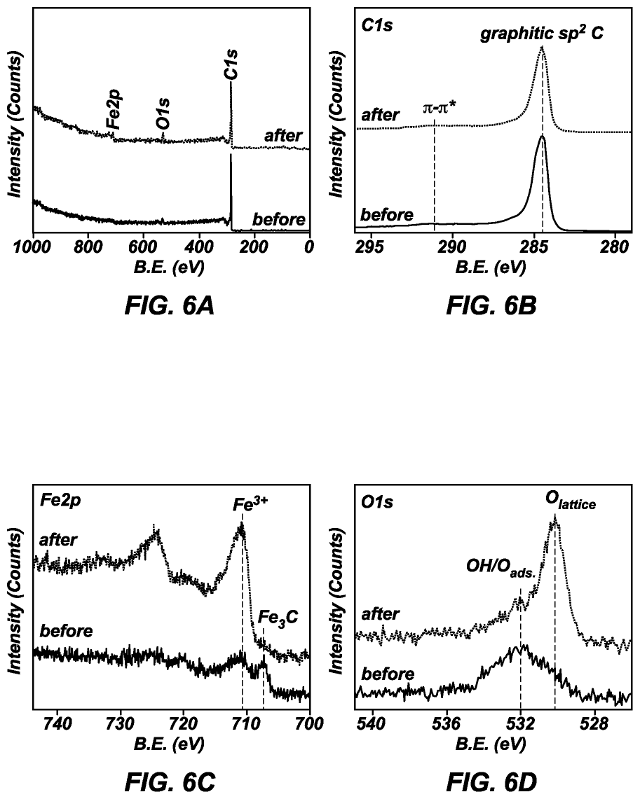

XPS measurements were conducted for an anode including CNTs described in Example 2 before and after reaction with an ethane feedstock at 700° C. for 100 hours. FIG. 6A illustrates a survey scan spectrum obtained from the XPS measurements, where the x-axis is binding energy (eV) and the y-axis is intensity. As shown by the survey scan spectrum of FIG. 6A, there were three detectable elements, C (C1s), O (O1s), and Fe (Fe2p), on the surface of the anode including CNTs.

FIG. 6B illustrates a C1s core-level spectrum obtained from the XPS measurements, where the x-axis is binding energy (eV) and the y-axis is intensity. The C1s core-level spectrum includes an intense asymmetric peak with a binding energy of about 284.5 eV and a characteristic π-π* shake-up structure with a binding energy centered around 291 and 294.5 eV. The peak at about 284.5 eV is attributed to graphitic C with sp² hybridization, which is consistent with the carbon structure of the CNTs.

FIG. 6C illustrates a Fe2p spectrum obtained from the XPS measurements, where the x-axis is binding energy (eV) and the y-axis is intensity. The Fe2p spectrum includes two prominent peaks at about 707.3 eV and 710.8 eV, which are attributed to the Fe carbide and oxide species, respectively. The Fe2p spectrum suggested the carburized Fe species existed not only in the bulk phase, but also on the surface of the CNTs of the anode. The oxidized Fe species may result from slight surface oxidation from exposure to ambient air. FIG. 6D illustrates an O1s spectrum obtained from the XPS measurements, where the x-axis is binding energy (eV) and the y-axis is intensity. Oxidation of the Fe species is supported by the peak at around 532.0 eV included in the Ols spectrum, which is attributed to surface adsorbed oxygen species, such as hydroxyls.

### Example 7

### Cell Testing Assemblies

Electrochemical cells including CNT anodes and PNC55 cathodes as described in Example 2 were sealed in a reactor using Aremco Ceramabond™ 552 adhesive with the cathode side of the electrochemical cells exposed. Silver mesh was used as a current collector with attached silver wires as leads.

Electrochemical cells including SFM anodes and PNC55 cathodes as described in Comparative Example 3 were sealed in a reactor using Aremco Ceramabond™ 552 adhesive with the cathode side of the electrochemical cells exposed. Silver mesh was used as a current collector with attached silver wires as leads.

### Example 8

### Electrochemical Protonic Ceramic Fuel Cell (PCFC) Testing

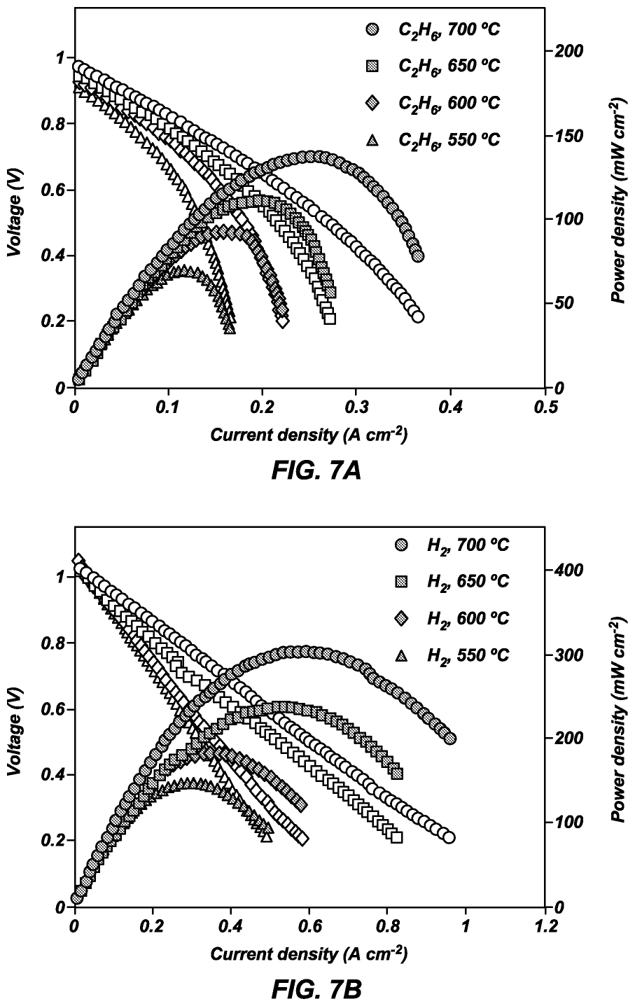

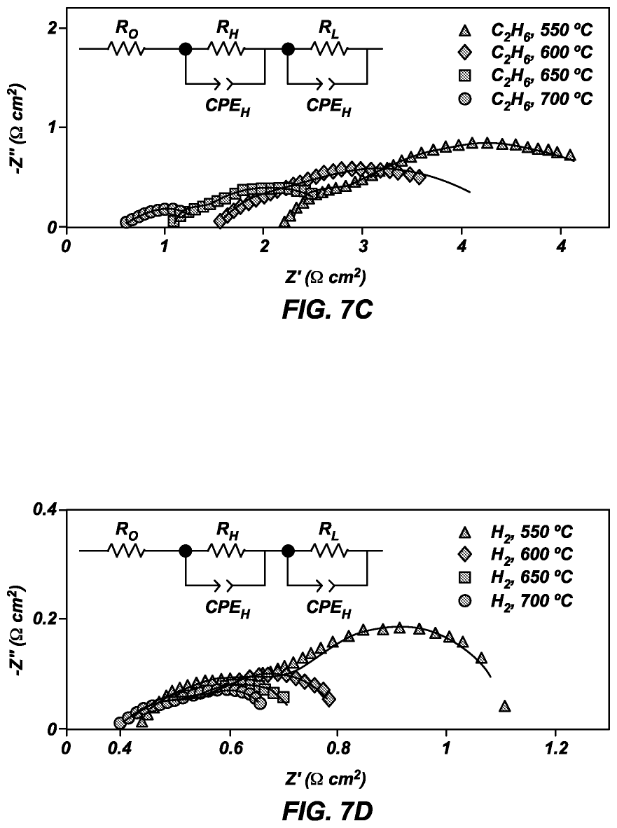

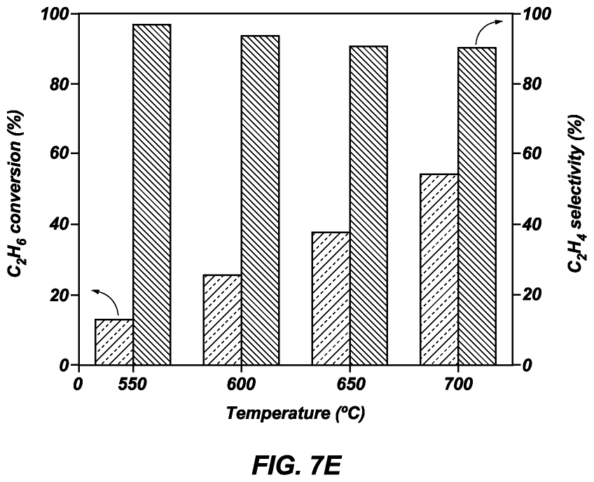

Electrochemical tests of electrochemical cells including CNT anodes and PNC55 cathodes described in Example 2 operating as fuel cells (e.g., PCFCs) were conducted. FIG. 7A is a current density vs. voltage plot (e.g., polarization curve) and a current density vs. power density plot (e.g., power density curve) of an electrochemical cell operating as a fuel cell at temperatures between 550° C. and 700° C. with C₂H₆ as the fuel and air as a feed gas to the cathode. As shown in FIG. 7A, the open circuit voltages (OCV) of the cell increased from 0.916 V at 550° C. to 0.951 V, 0.964 V, and 0.978 V at 600° C., 650° C., and 700° C., respectively. The trends observed with change in temperature were consistent with those predicted by thermodynamic calculations based on oxidative ethane dehydrogenation. The OCV measured at each temperature, however, was slightly higher than corresponding theoretical reversible potentials. A maximum power density (MPD) of 69 mW/cm was reached at 550° C. As shown in FIG. 7A, the MPD steadily increased from 69 mW/cm at 550° C. to 93 mW/cm, 111 mW/cm, and 137 mW/cm at 600° C., 650° C., and 700° C., respectively.

FIG. 7B is a current density vs. voltage plot (e.g., polarization curve) and a current density vs. power density plot (e.g., power density curve) of an electrochemical cell operating as a fuel cell at temperatures between 550° C. and 700° C. with H₂ as the fuel and air as a feed gas to the cathode. The MPD was significantly higher than when C₂H₆ was used as the fuel. As shown in FIG. 7B, the MPD was 145 mW/cm at 550° C., 183 mW/cm at 600° C., 237 mW/cm at 650° C., and 303 mW/cm at 700° C. The relatively lower MPDs obtained when C₂H₆ was used as the fuel suggest relatively slower C₂H₆ oxidation kinetics than that of H₂ on the CNTs of the anode.

Electrochemical impedance spectroscopy (EIS) measurements of the electrochemical cells were conducted under open-circuit voltage (OCV) at temperatures between 550° C. and 700° C. FIG. 7C illustrates a Cole-Cole plot obtained from the EIS measurements of the electrochemical cell operating as a fuel cell with C₂H₆ as the fuel and air as a feed gas to the cathode, where the x-axis is Z′ and the y-axis is −Z″, where Z′ and Z″ are the real and imaginary parts of the complex impedance, respectively. FIG. 7D illustrates a Cole-Cole plot an impedance spectrum obtained from the EIS measurements of the electrochemical cell operating as a fuel cell with H₂ as the fuel and air as a feed gas to the cathode. The symbols in FIGS. 7C and 7D correspond to experimentally determined impedance values, and the lines in FIGS. 7C and 7D correspond to simulated impedance values. An equivalent circuit, as shown in FIGS. 7C and 7D, composed of two Rₚ/CPE elements at high (R_{H}/CPE_{H}) and low (R_{L}/CPE_{L}) frequencies were used to simulate the simulated impedance values, where CPE stands for constant phase element and R_{H} and R_{L} stand for high and low resistance, respectively. The simulated impedance values for the electrochemical cell operating as a fuel cell with C₂H₆ as the fuel are shown below in Table 1. Table 2 includes the simulated impedance values for the electrochemical cell operating as a fuel cell with H₂ as the fuel.

TABLE 1
Ohmic and polarization resistances determined from EIS analysis of
the equivalent circuit of the electrochemical cell with C₂H₆ fuel.

| Anode | Temp. | Rₒ | R_{H} | R_{L} | Rₚ | R_{H}/R_{P} | Rₚ/(Rₒ + Rₚ) |
|---|---|---|---|---|---|---|---|
| Material | (° C.) | (Ω cm²) | (Ω cm²) | (Ω cm²) | (Ω cm²) | (%) | (%) |
| CNT | 550 | 2.21 | 1.08 | 2.05 | 3.13 | 34.5 | 58.6 |
| CNT | 600 | 1.55 | 0.76 | 1.42 | 2.17 | 34.7 | 58.3 |
| CNT | 650 | 1.07 | 0.32 | 1.16 | 1.48 | 21.9 | 58.2 |
| CNT | 700 | 0.59 | 0.16 | 0.48 | 0.64 | 25.0 | 52.0 |

TABLE 2
Ohmic and polarization resistances determined from EIS analysis of
the equivalent circuit of the electrochemical cell with H₂ fuel.

| Anode | Temp. | Rₒ | R_{H} | R_{L} | Rₚ | R_{H}/R_{P} | Rₚ/(Rₒ + Rₚ) |
|---|---|---|---|---|---|---|---|
| Material | (° C.) | (Ω cm²) | (Ω cm²) | (Ω cm²) | (Ω cm²) | (%) | (%) |
| CNT | 550 | 0.46 | 0.25 | 0.48 | 0.74 | 34.2 | 61.8 |
| CNT | 600 | 0.41 | 0.17 | 0.23 | 0.40 | 42.9 | 49.1 |
| CNT | 650 | 0.40 | 0.14 | 0.22 | 0.36 | 39.6 | 47.2 |
| CNT | 700 | 0.39 | 0.09 | 0.22 | 0.30 | 28.6 | 43.4 |

The ohmic resistance Rₒ of the electrochemical cell due to the resistance of ionic and electronic conduction were determined from the left intercepts of the EIS curve with the x-axis. With C₂H₆ as the fuel, the Rₒ of the electrochemical cell decreased with temperature from 2.21 Ωcm² at 550° C. to 1.55 Ωcm², 1.08 Ωcm², and 0.62 Ωcm² at 600° C., 650° C., and 700° C., respectively. A similar trend was observed for R_{H} and R_{L} as the temperature increased, indicating that mass and charge transfer at both electrodes were improved at higher temperatures. The total polarization resistance Rₚ (shown by the right intercept of the EIS curve with the x-axis minus Rₒ) was 3.21 Ωcm², 2.24 Ωcm², 1.49 Ωcm², and 0.63 Ωcm² at 550° C., 600° C., 650° C., and 700° C., respectively. At all temperatures, the total resistance in the electrochemical cell employing C₂H₆ as fuel was relatively larger than the total resistance when H₂ was used as fuel. The relatively larger resistance of the electrochemical cell employing C₂H₆ as fuel further suggests that the oxidation kinetics of C₂H₆ was slower than that of H₂ on the CNTs of the anode.

The catalytic performance of the CNT anode in C₂H₆ dehydrogenation to C₂H₄ was evaluated and the results are shown in the chart depicted in FIG. 7E. The chart of FIG. 7E displays temperature vs. C₂H₆ conversion and temperature vs. C₂H₄ selectivity at OCV. As shown, the C₂H₆ conversion increased from 12.7% at 550° C. to 25.3% at 600° C., 37.6% at 650° C., and 53.9% at 700° C. In contrast, the corresponding selectivity to C₂H₄ product slightly decreased from 96% to 90% from the accelerated C—C bond breaking rates at higher temperatures.

### Example 9

### Comparative Electrochemical PCFC Testing

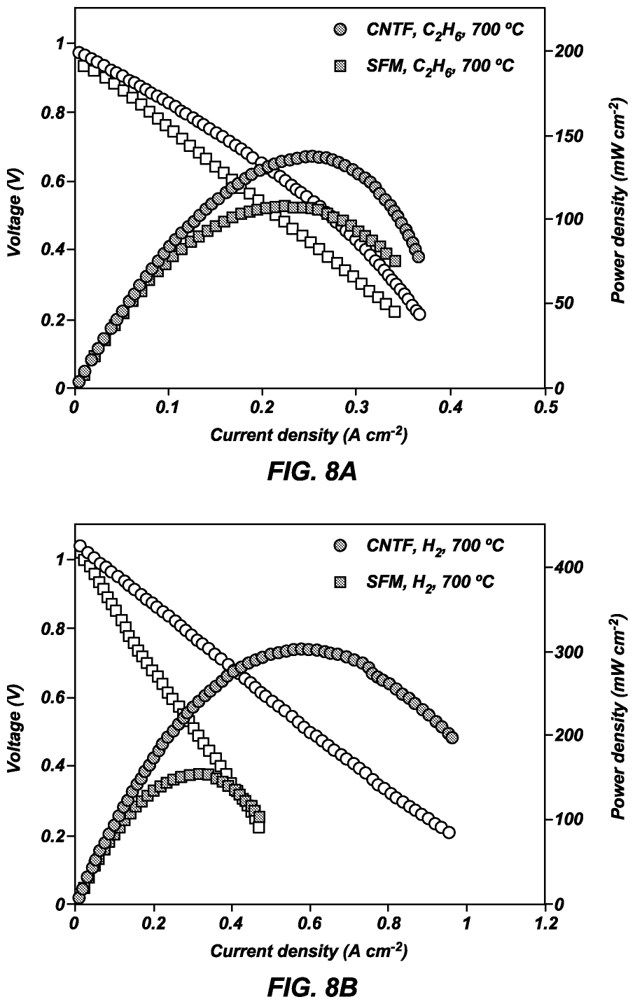

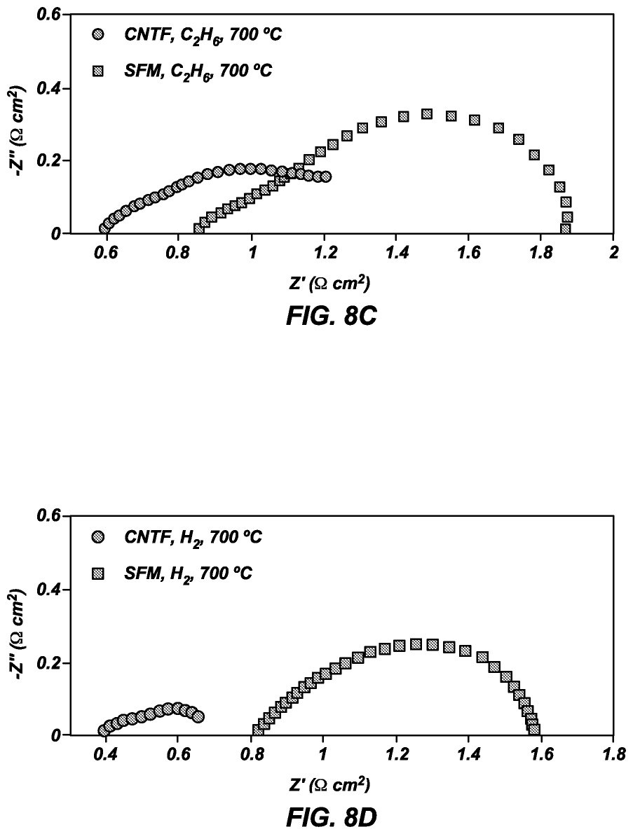

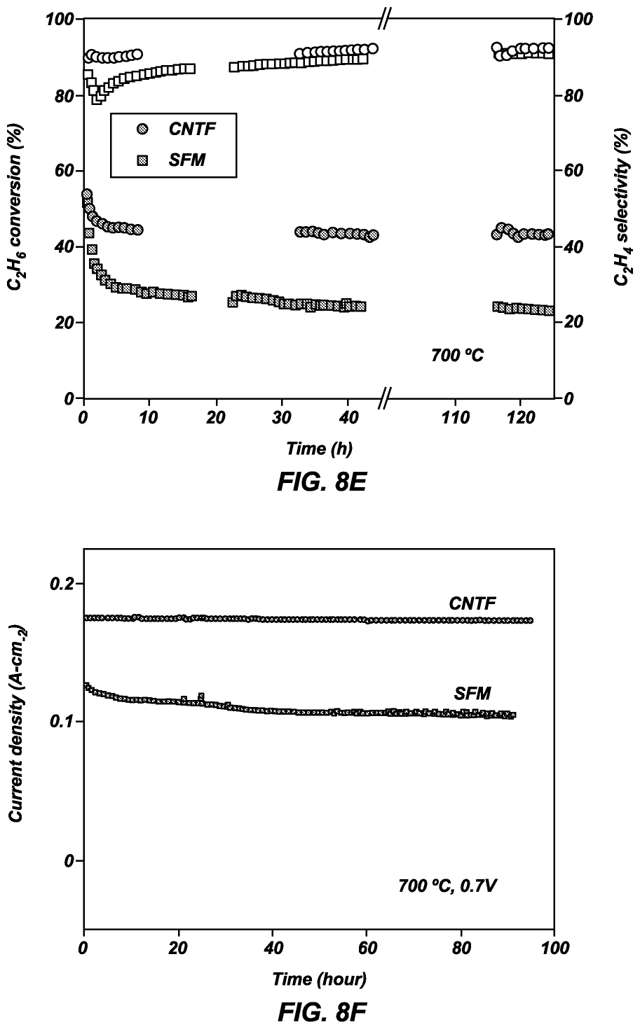

Electrochemical tests of electrochemical cells including SFM anodes and PNC55 described in Comparative Example 3 operating as fuel cells (e.g., PCFCs) were conducted. FIG. 8A is a current density vs. voltage plot (e.g., polarization curve) and a current density vs. power density plot (e.g., power density curve) of an electrochemical cell including an SFM anode and an electrochemical cell including a CNT anode described in Example 2 each operating as a fuel cell at a temperature of 700° C. with C₂H₆ as fuel. The MPD at 700° C. of the electrochemical cell including the SFM anode with C₂H₆ as fuel was determined to be 107 mW/cm², which is lower than the corresponding MPD (137 mW/cm²) of the electrochemical cell with the CNT anode by about 28%. FIG. 8B is a is a current density vs. voltage plot (e.g., polarization curve) and a current density vs. power density plot (e.g., power density curve) of the electrochemical cell including an SFM anode and the electrochemical cell including a CNT anode each operating as a fuel cell at a temperature of 700° C. with H₂ as fuel. The MPD at 700° C. of the electrochemical cell including the SFM anode with H₂ as fuel was determined to be 154 mW/cm² and the corresponding MPD of the electrochemical cell with the CNT anode was determined to be 303 mW/cm².

EIS measurements of the electrochemical cells were conducted under OCV at a temperature of 700° C. FIG. 8C illustrates a Cole-Cole plot obtained from the EIS measurements of the electrochemical cell including the SFM anode and the electrochemical cell including the CNT anode each operating as a fuel cell with C₂H₆ as fuel, where the x-axis is Z′ and the y-axis is-Z″, where Z′ and Z″ are the real and imaginary parts of the complex impedance, respectively. As shown in FIG. 8C, the Rₒ (shown by the left intercept of the EIS curve with the x-axis) and Rₚ (shown by the right intercept of the EIS curve with the x-axis minus Rₒ) of the electrochemical cell including the SFM anode were 0.86 Ωcm² and 1.02 Ωcm², respectively. The Rₒ and Rₚ of the electrochemical cell including the SFM anode were about 46% and 59% greater, respectively, than the corresponding values for the electrochemical cell with the CNT anode. FIG. 8D illustrates a Cole-Cole plot obtained from the EIS measurements of the electrochemical cell including the SFM anode and the electrochemical cell including the CNT anode each operating as a fuel cell with H₂ as fuel. As shown in FIG. 8D, the Rₒ and Rₚ of the electrochemical cell including the SFM anode were 0.82 Ωcm² and 0.76 Ωcm², respectively. The Rₒ and Rₚ of the electrochemical cell including the SFM anode were about 110% and 153% greater, respectively, than the corresponding values for the electrochemical cell with the CNT anode. The relatively lower Rₒ of the electrochemical cell with the CNT anode is attributed to a higher electrical conductivity of the CNT anode than the SFM anode. The relatively lower Rₚ of the electrochemical cell with the CNT anode is attributed to higher rates of mass and charge transfer in the CNT anode than the SFM anode.

The catalytic performance of the SFM anode with exsolved Fe nanoparticles in C₂H₆ dehydrogenation to C₂H₄ was evaluated for comparison to the catalytic performance of the CNT anode, and the results are shown in the chart depicted in FIG. 8E. The initial C₂H₆ conversion and C₂H₄ selectivity of the SFM anode were determined to be about 51.9% and 85.5%, respectively, which are comparable to those observed for the CNT anode (53.9% C₂H₆ conversion and 90% C₂H₄ selectivity). However, the activity of the SFM anode catalyst degraded significantly faster than the CNT anode catalyst during a continuous reaction for over 120 hours. The activity of the SFM anode catalyst degraded by 54% and the activity of the CNT anode catalyst degraded by 14.6%.

Electrochemical performance stability of the electrochemical cell including the SFM anode and the electrochemical cell including the CNT anode was evaluated under a constant applied potential of 0.7 V with C₂H₆ as fuel at 700° C. FIG. 8F is a time vs. current density plot for both the electrochemical cell including the SFM anode and the electrochemical cell including the CNT anode. As shown in FIG. 8F, the electrochemical cell including the SFM anode experienced substantial degradation. The current density of the electrochemical cell including the SFM anode declined by 16.1% after running for 90 hours as a result of accumulative coke deposition on the SFM anode. Under the same conditions, the electrochemical cell including the CNT anode showed negligible degradation and the current density declined by about 1.4% after running for about 100 hours, suggesting the CNT anode suppressed carbon (e.g., coke) deposition.

The microstructure of the interface between the CNT anode and the BZCYYb electrolyte was examined by SEM after the electrochemical performance stability test. Adhesion between the CNT anode and the BZCYYb electrolyte remained strong and stable. Elemental mapping analysis showed that the Fe species within the CNT anode remained highly dispersed throughout the CNT anode without any signs of agglomeration. The surface chemical states of the CNT anode were characterized by XPS and showed no substantial changes after the electrochemical performance stability test, suggesting that no contamination or additional carbon (e.g., coke) deposition occurred, and that the CNTs structure was not substantially altered during the electrochemical performance stability test.

Additional non-limiting example embodiments of the disclosure are set forth below.

Embodiment 1: An electrochemical cell comprising: a first electrode comprising carbon nanotubes and one or more catalysts formulated to accelerate one or more non-oxidative deprotonation reactions to produce at least one hydrocarbon compound, H⁺, and e⁻ from at least one other hydrocarbon compound; a second electrode; and an electrolyte between the first electrode and the second electrode, wherein the carbon nanotubes are oriented at least substantially vertically relative to the electrolyte.

Embodiment 2: The electrochemical cell of Embodiment 1, wherein the electrolyte comprises a perovskite material directly adjacent to the carbon nanotubes of the first electrode.

Embodiment 3: The electrochemical cell of Embodiment 1 or Embodiment 2, wherein the one or more catalysts comprise at least one transition metal element.

Embodiments 4: The electrochemical cell of any of Embodiments 1 through 3, wherein the one or more catalysts comprise one or more of Fe₃C and Ni₃C.

Embodiment 5: The electrochemical cell of any of Embodiments 1 through 4, wherein the one or more catalysts comprise particles having a diameter within a range of from about 1 nm to about 50 nm.

Embodiment 6: The electrochemical cell of any of Embodiments 1 through 5, wherein the one or more catalysts are at least substantially homogeneously distributed throughout the first electrode.

Embodiment 7: The electrochemical cell of any of Embodiments 1 through 6, wherein the carbon nanotubes exhibit a length within a range of from about 5 μm to about 50 μm.

Embodiment 8: The electrochemical cell of any of Embodiments 1 through 7, wherein the carbon nanotubes exhibit a volumetric density on the electrolyte within a range of from about 0.02 g/cm³ to about 0.50 g/cm³.

Embodiment 9: A method of forming an electrochemical cell, the method comprising: forming an electrolyte material exhibiting an ionic conductivity greater than or equal to about 10⁻² S/cm at one or more temperatures within a range of from about 350° C. to about 650° C.; forming a first electrode comprising carbon nanotubes and one or more catalysts on the electrolyte material; and forming a second electrode on the electrolyte material opposite the first electrode.

Embodiment 10: The method of Embodiment 9, wherein forming the first electrode comprises forming the carbon nanotubes and the one or more catalysts directly on the electrolyte material by chemical vapor deposition comprising: introducing a precursor solution comprising at least one organometallic material and at least one organic solvent to the electrolyte material in a reactor; reacting the at least one organometallic material with the electrolyte material, a first portion of metal atoms of the at least one organometallic material forming nanocatalyst clusters on the electrolyte material; and growing the carbon nanotubes on the nanocatalyst clusters, the carbon nanotubes including a second portion of metal atoms of the at least one organometallic material disposed throughout the CNTs, the second portion of metal atoms forming the one or more catalysts.

Embodiment 11: The method of Embodiment 10, wherein introducing the precursor solution comprising the at least one organometallic material and the at least one organic solvent comprises introducing the at least one organometallic material comprising one or more of ferrocene and bis(cyclopentadienyl) nickel (II) and the at least one organic solvent.

Embodiment 12: The method of Embodiment 10 or Embodiment 11, wherein introducing the precursor solution comprising the at least one organometallic material and the at least one organic solvent comprises introducing the at least one organometallic material and the at least one organic solvent comprising one or more of an alkene, toluene, and xylene.

Embodiment 13: The method of any of Embodiments 10 through 12, wherein introducing the precursor solution comprising the at least one organometallic material and the at least one organic solvent comprises introducing the precursor solution including a ratio of the at least one organometallic material to the at least one organic solvent within a range of from about 0.5 g:20 mL to about 5.0 g:20 mL.

Embodiment 14: The method of any of Embodiments 9 through 13, wherein forming the first electrode comprises forming the carbon nanotubes to exhibit a length of about 10 μm and a volumetric density within a range of from about 0.02 g/cm³ to about 0.50 g/cm³.

Embodiment 15: The method of any of Embodiments 9 through 14, wherein forming the electrolyte material comprises forming the electrolyte material to exhibit a thickness of at least about 100 μm.

Embodiment 16: A hydrocarbon activation system comprising: a source of one or more hydrocarbon compounds; and an electrochemical apparatus in fluid communication with the source of one or more hydrocarbon compounds, and comprising: a housing structure configured and positioned to receive a hydrocarbon reactant stream including one or more hydrocarbon compounds from the source of one or more hydrocarbon compounds; and an electrochemical cell within the housing structure and comprising: a first electrode comprising carbon nanotubes and one or more catalysts substantially homogeneously distributed throughout the carbon nanotubes and formulated to accelerate one or more deprotonation reactions to produce at least one other hydrocarbon compound, H⁺, and e⁻ from the one or more hydrocarbon compounds; a second electrode; and an electrolyte between the first electrode and the second electrode, wherein the carbon nanotubes are oriented at least substantially vertically relative to the electrolyte.

Embodiment 17: The hydrocarbon activation system of Embodiment 16, wherein the carbon nanotubes exhibit a volumetric density on the electrolyte of about 0.12 g/cm³.

Embodiment 18: The hydrocarbon activation system of Embodiment 16 or Embodiment 17, wherein the first electrode exhibits a thickness within a range of from about 5 μm to about 50 μm.

Embodiment 19: The hydrocarbon activation system of any of Embodiments 16 through 18, wherein the one or more catalysts are further formulated to accelerate one or more coupling reaction rates to synthesize one or more higher hydrocarbon products from the produced at least one other hydrocarbon compound.

Embodiment 20: The hydrocarbon activation system of any of Embodiments 16 through 19, further comprising a heating apparatus configured and positioned to heat one or more of the hydrocarbon reactant stream and at least a portion of the electrochemical apparatus.

While the disclosure is susceptible to various modifications and alternative forms, specific embodiments have been shown by way of example in the drawings and have been described in detail herein. However, the disclosure is not intended to be limited to the particular forms disclosed. Rather, the disclosure encompasses all modifications, equivalents, and alternatives falling within the scope of the disclosure as defined by the following appended claims and their legal equivalents.

1. An electrochemical cell comprising:
a first electrode comprising carbon nanotubes and one or more catalysts formulated to accelerate one or more non-oxidative deprotonation reactions to produce at least one hydrocarbon compound, H⁺, and e⁻ from at least one other hydrocarbon compound;
a second electrode; and
an electrolyte between the first electrode and the second electrode,
wherein the carbon nanotubes are oriented at least substantially vertically relative to the electrolyte.

2. The electrochemical cell of claim 1, wherein the electrolyte comprises a perovskite material directly adjacent to the carbon nanotubes of the first electrode.

3. The electrochemical cell of claim 1, wherein the one or more catalysts comprise at least one transition metal element.

4. The electrochemical cell of claim 1, wherein the one or more catalysts comprise one or more of Fe₃C and Ni₃C.

5. The electrochemical cell of claim 1, wherein the one or more catalysts comprise particles having a diameter within a range of from about 1 nm to about 50 nm.

6. The electrochemical cell of claim 1, wherein the one or more catalysts are at least substantially homogeneously distributed throughout the first electrode.

7. The electrochemical cell of claim 1, wherein the carbon nanotubes exhibit a length within a range of from about 5 μm to about 50 μm.

8. The electrochemical cell of claim 1, wherein the carbon nanotubes exhibit a volumetric density on the electrolyte within a range of from about 0.02 g/cm³ to about 0.50 g/cm³.

9. A method of forming an electrochemical cell, the method comprising:
forming an electrolyte material exhibiting an ionic conductivity greater than or equal to about 10⁻² S/cm at one or more temperatures within a range of from about 350° C. to about 650° C.;
forming a first electrode comprising carbon nanotubes and one or more catalysts on the electrolyte material; and
forming a second electrode on the electrolyte material opposite the first electrode.

10. The method of claim 9, wherein forming the first electrode comprises forming the carbon nanotubes and the one or more catalysts directly on the electrolyte material by chemical vapor deposition comprising:
introducing a precursor solution comprising at least one organometallic material and at least one organic solvent to the electrolyte material in a reactor;
reacting the at least one organometallic material with the electrolyte material, a first portion of metal atoms of the at least one organometallic material forming nanocatalyst clusters on the electrolyte material; and
growing the carbon nanotubes on the nanocatalyst clusters, the carbon nanotubes including a second portion of metal atoms of the at least one organometallic material disposed throughout the carbon nanotubes, the second portion of metal atoms forming the one or more catalysts.

11. The method of claim 10, wherein introducing the precursor solution comprising the at least one organometallic material and the at least one organic solvent comprises introducing the at least one organometallic material comprising one or more of ferrocene and bis(cyclopentadienyl) nickel (II) and the at least one organic solvent.

12. The method of claim 10, wherein introducing the precursor solution comprising the at least one organometallic material and the at least one organic solvent comprises introducing the at least one organometallic material and the at least one organic solvent comprising one or more of an alkene, toluene, and xylene.

13. The method of claim 10, wherein introducing the precursor solution comprising the at least one organometallic material and the at least one organic solvent comprises introducing the precursor solution including a ratio of the at least one organometallic material to the at least one organic solvent within a range of from about 0.5 g:20 mL to about 5.0 g:20 mL.

14. The method of claim 9, wherein forming the first electrode comprises forming the carbon nanotubes to exhibit a length of about 10 μm and a volumetric density on the electrolyte material within a range of from about 0.02 g/cm³ to about 0.50 g/cm³.

15. The method of claim 9, wherein forming the electrolyte material comprises forming the electrolyte material to exhibit a thickness of at least about 100 μm.

16. A hydrocarbon activation system comprising:
a source of one or more hydrocarbon compounds; and
an electrochemical apparatus in fluid communication with the source of one or more hydrocarbon compounds, and comprising:
a housing structure configured and positioned to receive a hydrocarbon reactant stream including one or more hydrocarbon compounds from the source of one or more hydrocarbon compounds; and
an electrochemical cell within the housing structure and comprising:
a first electrode comprising carbon nanotubes and one or more catalysts substantially homogeneously distributed throughout the carbon nanotubes and formulated to accelerate one or more deprotonation reactions to produce at least one other hydrocarbon compound, H⁺, and e⁻ from the one or more hydrocarbon compounds;
a second electrode; and
an electrolyte between the first electrode and the second electrode,
wherein the carbon nanotubes are oriented at least substantially vertically relative to the electrolyte.

17. The hydrocarbon activation system of claim 16, wherein the carbon nanotubes exhibit a volumetric density on the electrolyte of about 0.12 g/cm³.

18. The hydrocarbon activation system of claim 16, wherein the first electrode exhibits a thickness within a range of from about 5 μm to about 50 μm.

19. The hydrocarbon activation system of claim 16, wherein the one or more catalysts are further formulated to accelerate one or more coupling reaction rates to synthesize one or more higher hydrocarbon products from the produced at least one other hydrocarbon compound.

20. The hydrocarbon activation system of claim 16, further comprising a heating apparatus configured and positioned to heat one or more of the hydrocarbon reactant stream and at least a portion of the electrochemical apparatus.
